(19) United States
(12) Patent Application Publication
(10) Pub. No.: US 2005/0216440 A1
(43) Pub. Date: Sep. 29, 2005

(54) Information processing apparatus and information processing method

(75) Inventor: Masanori Wakai, Kawasaki-shi (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Ohta-ku (JP)

(21) Appl. No.: 11/085,963

(22) Filed: Mar. 22, 2005

(30) Foreign Application Priority Data
Mar. 25, 2004 (JP) 2004-088320

(51) Int. Cl. G06F 17/30

(52) U.S. Cl. 707/1

(57) ABSTRACT

An information processing apparatus and method that allows both a schedule and associated process information to be displayed at corresponding time positions in a calendar view form is provided. An indicator indicating type of process performed on each data is displayed such that the indicator is superimposed on an indicator indicating the data. This permits a user to easily and quickly retrieve data based on the schedule and to easily and quickly retrieve data based on the schedule and the process performed. In addition, displaying of both the schedule and data in the same single calendar view form permits the user to easily determine whether there is data associated with the schedule.

### BACKGROUND OF THE INVENTION

1. Field of the Invention

The present invention relates to an information processing apparatus and an information processing method, and more particularly, to an information processing apparatus and an information processing method for simultaneously displaying both a schedule and other data that occurs at a particular time such that the other data is displayed in relation to the schedule in a single calendar view form.

2. Description of the Related Art

In information processing apparatus, it is known to display schedule data in the form of a calendar.

In such an information processing apparatus, schedule data is handled, for example, as shown in a flow chart of FIG. 41. In step S4101, a calendar frame is displayed. In step S4102, schedule data is acquired. In step S4103, the schedule data acquired in step S4102 is placed at the top of a schedule data set. In step S4104, a determination is made whether the end of the schedule data set has been achieved. In step S4105, the schedule data located at the top of the schedule data set is displayed in the calendar frame. In step S4106, next schedule data is acquired.

As shown in FIG. 42, each schedule data displayed in the process described above with reference to FIG. 41 includes a start time (start), an end time (end), and a schedule content (object).

FIGS. 43 to 50 show examples of calendar forms in which schedule data is displayed.

In the example shown in FIG. 43, a day on which there is something scheduled is marked on a calendar.

FIG. 44 shows an example of a monthly schedule view format in which a short description of a schedule is displayed in a day box of a corresponding day.

FIG. 45 shows an example of a weekly schedule view format in which a short description of a scheduled event/job and a scheduled time is displayed in a day box of a corresponding day.

FIG. 46 shows an example of a daily schedule view format in which a date and an event/job are described.

FIG. 47 shows an example of a yearly schedule view format in which a day on which there is something scheduled is marked.

FIG. 48 shows an example of a time-month schedule view format in which each event/job is displayed in a row or rows corresponding to a scheduled time and in a column corresponding to a scheduled day.

FIG. 49 shows an example of a time-week schedule view format in which each event/job is displayed in a row or rows corresponding to a scheduled time and in a column corresponding to a scheduled day.

FIG. 50 shows an example of a time-day schedule view format in which each event/job is displayed in a row or rows corresponding to a scheduled time.

In the conventional information processing apparatus for managing a schedule, as described above, schedule data is displayed in a calendar view format, and a user manages a schedule in accordance with the displayed schedule data. However, the conventional information processing apparatus is capable of displaying only schedule data and is not capable of displaying other data that occurs from time to time in the same view form.

Japanese Patent Laid-Open No. 5-035737 discloses an information processing apparatus capable of managing document data by time, and displaying a document icon in a calendar. However, the technique disclosed in Japanese Patent Laid-Open No. 5-035737 is not capable of simultaneously displaying both document data and a schedule in the same calendar. Therefore, it is not easy to find associated document data directly from the schedule. It is difficult to display information indicating what processing was performed on document data by a user, as well as display information indicating processing associated with an event/job in the same calendar.

Japanese Patent Laid-Open No. 7-282129 discloses a technique of storing files and schedule data such that schedule data is related to an associated file specified by a user. In this technique, schedule data can be displayed in a calendar form. If a user selects a particular scheduled event/job from the schedule displayed in the calendar form, another window appears and files associated with the scheduled event/job are displayed in the form of a list in the window. However, in the technique disclosed in Japanese Patent Laid-Open No. 7-282129, files must be explicitly related, by a user to scheduled events/jobs, otherwise files cannot be retrieved based on schedule data. Even in this technique, both schedule and files are not displayed in the same calendar form.

In a control terminal with a display as disclosed in Japanese Patent Laid-Open No. 2000-357037, data such as e-mail data or memo data are stored in relation to date/time, and icons associated with data are displayed in a calendar form. However, in the technique disclosed in Japanese Patent Laid-Open No. 2000-357037, a schedule is not displayed in the same calendar form. Because of the inability of displaying data such as e-mail data and a schedule data in the same calendar form, a user can not search for data based on the schedule.

Japanese Patent Laid-Open No. 2001-249983 discloses a customer analysis system capable of displaying sales performance data in a calendar form. However, the customer analysis system disclosed in Japanese Patent Laid-Open No. 2001-249983 is not capable of displaying a schedule in the same calendar form. Because of the inability to display sales performance data and a schedule data in the same calendar form, a user can not search for data based on the schedule.

In a document presentation apparatus disclosed in Japanese Patent Laid-Open No. 8-077145, a history of operations performed on specified data is stored, and icons indicating types of operations performed on data are displayed. However, the apparatus disclosed in Japanese Patent Laid-Open No. 8-077145 is not capable of displaying a schedule in the same calendar form. Because of the inability to display data and a schedule in the same calendar form, a user can not search for data based on the schedule.

Japanese Patent Laid-Open No. 2000-163439 discloses an electronic file search system in which a history in terms of operations performed on electronic files is stored, and data can be searched for based on the operation history. However, the system disclosed in Japanese Patent Laid-Open No. 2000-163439 is not capable of displaying a schedule in a calendar form. Because of the inability to display files and a schedule in a single calendar form, a user can not search for data based on the schedule.

### SUMMARY OF THE INVENTION

In view of the above, the present invention provides a technique of simultaneously displaying both a schedule and other data that occurs at a particular time such that the other data is displayed in relation to the schedule in a single calendar view form. An indicator indicating a process performed on the data may be displayed in a superimposed manner.

The technique of displaying a schedule and data in the above described manner allows a user to easily retrieve data based on the schedule. Displaying of both the schedule and data in the same calendar view form allows the user to determine whether there is data associated with the schedule. Displaying of the process performed on data in the superimposed manner allows the user to easily and quickly retrieve data based on the schedule and the process performed on the data.

In an aspect of the present invention, an information processing apparatus is provided, comprising a schedule database in which schedule data is stored, and a process information database in which process information is stored together with information indicating a time at which the information was processed, display means for displaying schedule data stored in the schedule database and process information stored in the process information database such that the schedule data and the process information are displayed at a position corresponding to a scheduled time in a calendar view form.

In another aspect of the present invention, an information processing method is provided for controlling an information processing apparatus comprising a schedule database in which schedule data is stored, and a process information database in which process information is stored together with information indicating a time at which the information was processed, the method comprising the step of displaying schedule data stored in the schedule database and process information stored in the process information database such that the schedule data and the process information are displayed at a position corresponding to a scheduled time in a calendar view form.

In yet another aspect of the present invention, computer-executable process steps are provided for controlling a computer by using a schedule database in which schedule data is stored, and a process information database in which process information is stored together with time information indicating a time at which the information was processed, the computer-executable process steps causing the computer to execute the step of displaying schedule data stored in the schedule database and process information stored in the process information database such that the schedule data and the process information are displayed at a position corresponding to a scheduled time in a calendar view form.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing a hardware configuration of an information processing apparatus according to a first embodiment of the invention.

FIG. 2 is a flow chart showing an outline of a process according to a first embodiment.

FIG. 3 is a flow chart showing a calendar view form display process according to the first embodiment.

FIG. 4 is a flow chart showing a process information display process according to the first embodiment.

FIG. 5 is a flow chart showing a process information indicator generation process according to the first embodiment.

FIG. 6 is a flow chart showing a process information type indicator generation process according to the first embodiment.

FIG. 7 is a diagram showing a process information database according to the first embodiment.

FIG. 8 is a diagram showing a data type correspondence table according to the first embodiment.

FIG. 9 is a diagram showing a yearly schedule view form according to the first embodiment.

FIG. 10 is a diagram showing a monthly schedule view form according to the first embodiment.

FIG. 11 is a diagram showing a weekly schedule view form according to the first embodiment.

FIG. 12 is a diagram showing a daily schedule view form according to the first embodiment.

FIG. 13 is a diagram showing a time-year schedule view form according to the first embodiment.

FIG. 14 is a diagram showing a time-month schedule view form according to the first embodiment.

FIG. 15 is a diagram showing a time-week schedule view form according to the first embodiment.

FIG. 16 is a diagram showing a time-day schedule view form according to the first embodiment.

FIG. 17 is a flow chart showing a process information indicator generation process according to a second embodiment.

FIG. 18 is a diagram showing a process information database according to the second embodiment.

FIG. 19 is a diagram showing a process type correspondence table according to the second embodiment.

FIG. 20 is a diagram showing a time-day schedule view form according to the second embodiment.

FIG. 21 is a flow chart showing an outline of a process according to a third embodiment.

FIG. 22 is a flow chart showing a process information list display process according to the third embodiment.

FIG. 23 is a diagram showing a process information list view form according to the third embodiment.

FIG. 24 is a flow chart showing an outline of a process according to a fourth embodiment.

FIG. 25 is a flow chart showing a calendar view form display process according to the fourth embodiment.

FIG. 26 is a flow chart showing a process type designation process according to the fourth embodiment.

FIG. 27 is a flow chart showing a process of determining whether process information should be displayed, according to the fourth embodiment.

FIG. 28 is a flow chart showing an AND determination process in the process of determining whether process information should be displayed, according to the fourth embodiment.

FIG. 29 is a flow chart showing an OR determination process in the process of determining whether process information should be displayed, according to the fourth embodiment.

FIG. 30 is a diagram showing a process information database according to the fourth embodiment.

FIG. 31 is a diagram showing process type designation information according to the fourth embodiment.

FIG. 32 is a diagram showing a time-day schedule view form according to the fourth embodiment.

FIG. 33 is a diagram showing process type designation information according to the fourth embodiment.

FIG. 34 is a diagram showing a time-day schedule view form according to the fourth embodiment.

FIG. 35 is a diagram showing process type designation information according to the fourth embodiment.

FIG. 36 is a diagram showing a time-day schedule view form according to the fourth embodiment.

FIG. 37 is a diagram showing process type designation information according to the fourth embodiment.

FIG. 38 is a diagram showing a time-day schedule view form according to the fourth embodiment.

FIG. 39 is a diagram showing process type designation information according to the fourth embodiment.

FIG. 40 is a diagram showing a time-day schedule view form according to the fourth embodiment.

FIG. 41 is a flow chart showing a calendar view form display process performed by a conventional information processing apparatus.

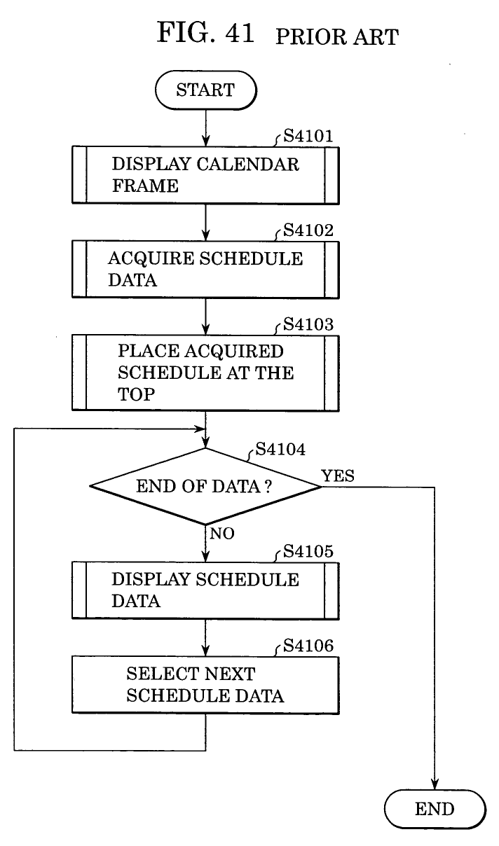

FIG. 42 is a diagram showing a schedule database used in a conventional information processing apparatus.

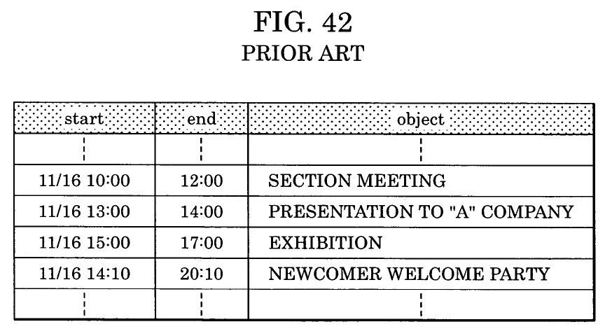

FIG. 43 is a diagram showing a yearly schedule view form used in a conventional information processing apparatus.

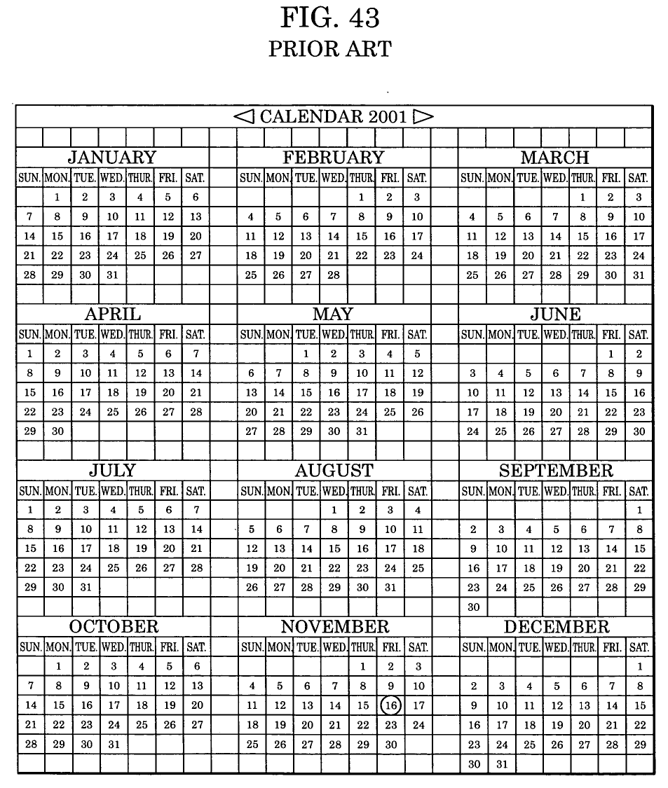

FIG. 44 is a diagram showing a monthly schedule view form used in a conventional information processing apparatus.

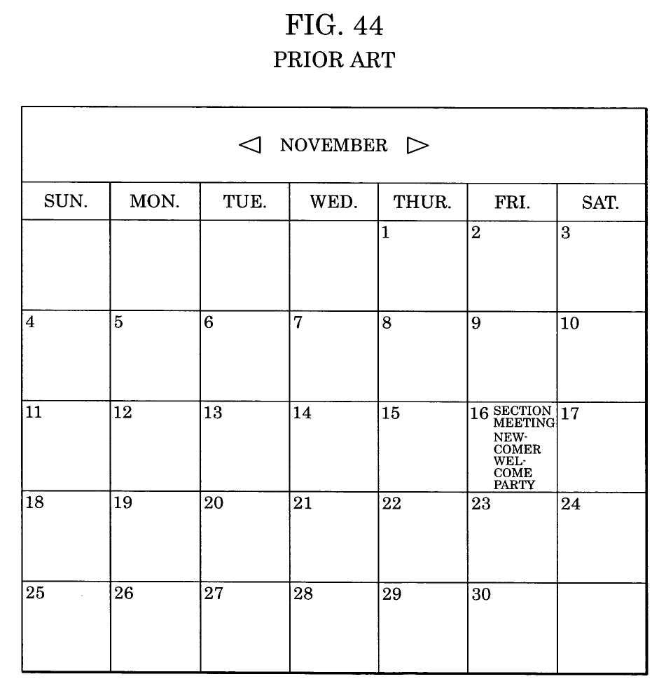

FIG. 45 is a diagram showing a weekly schedule view form used in a conventional information processing apparatus.

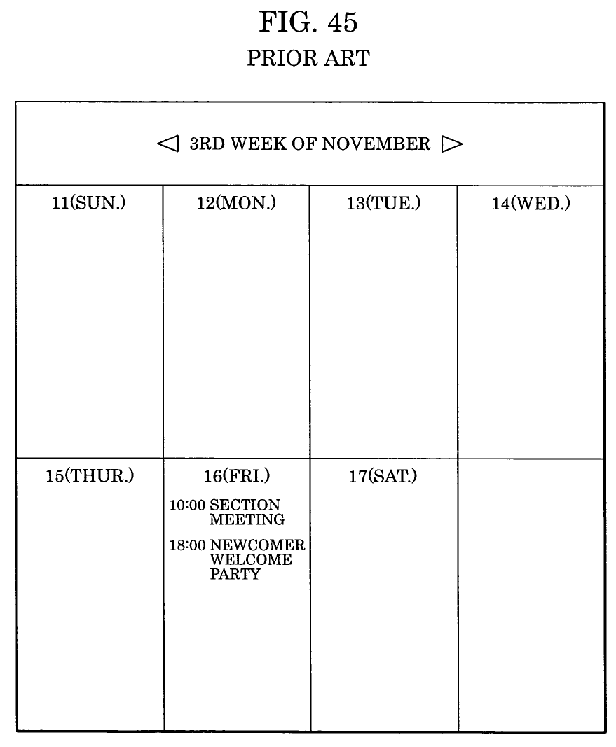

FIG. 46 is a diagram showing a daily schedule view form used in a conventional information processing apparatus.

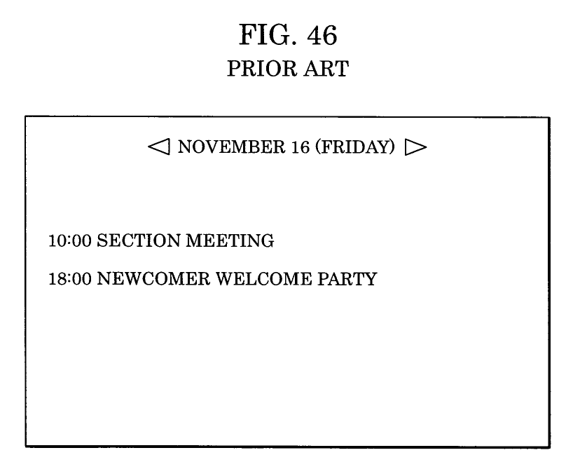

FIG. 47 is a diagram showing a time-year schedule view form used in a conventional information processing apparatus.

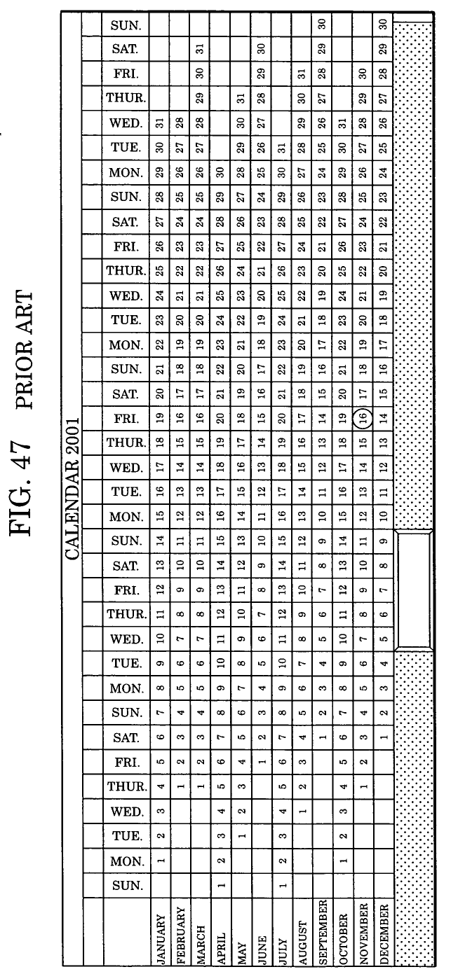

FIG. 48 is a diagram showing a time-month schedule view form used in a conventional information processing apparatus.

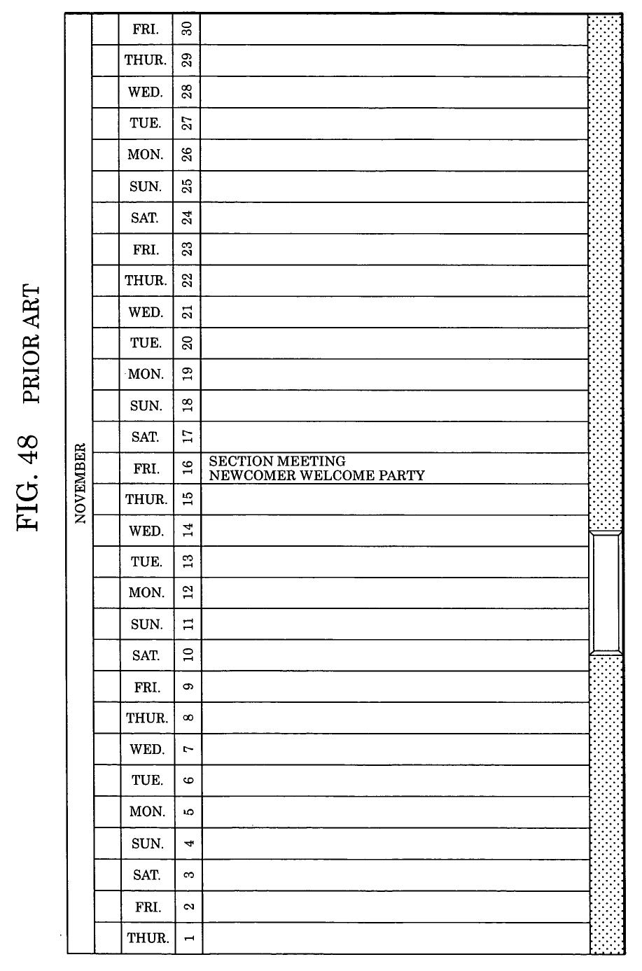

FIG. 49 is a diagram showing a time-week schedule view form used in a conventional information processing apparatus.

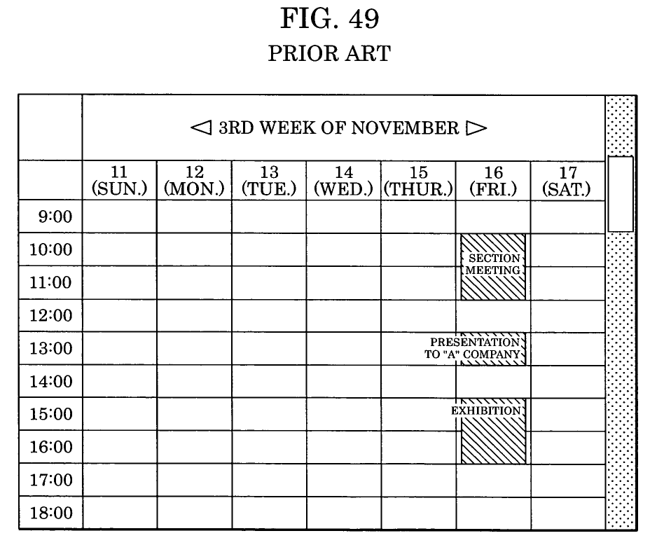

FIG. 50 is a diagram showing a time-day schedule view form used in a conventional information processing apparatus.

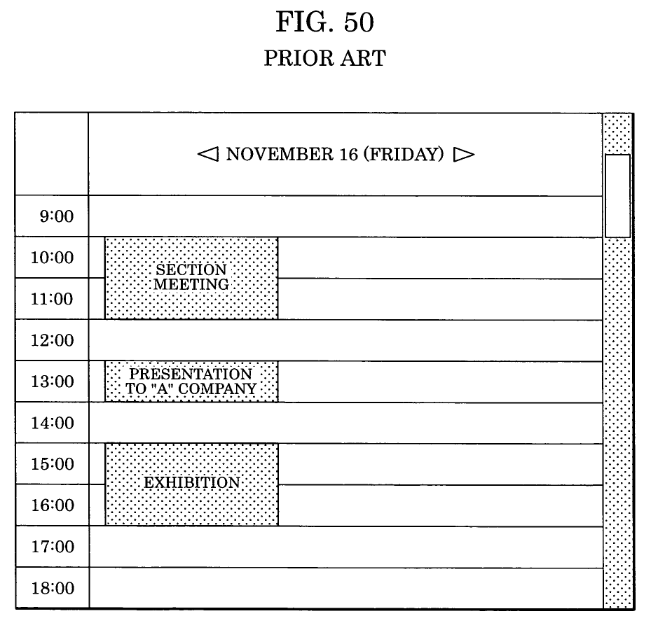

### DESCRIPTION OF THE EMBODIMENTS

### First Embodiment

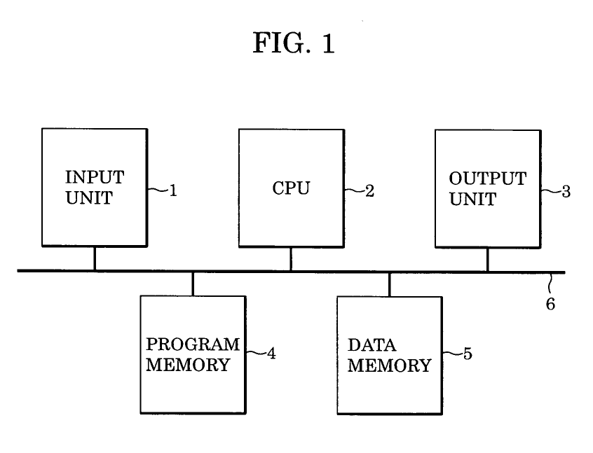

FIG. 1 is a block diagram showing a hardware configuration of an information processing apparatus according to a first embodiment of the present invention.

As shown in FIG. 1, the information processing apparatus has a CPU 2 connected to a bus 6. The CPU 2 performs various operations and logical decisions needed in processing and controls various devices connected via the bus 6. An input unit 1 for inputting information (data) and an output unit 3 for outputting information (data) are connected to the bus 6. A display such as an LCD or a CRT or a recording apparatus such as a printer is used as the output unit 3.

The bus 6 is also connected to a program memory 4. The program memory 4 stores programs executed by the CPU 2 to perform processing described later with reference to flow charts and also stores other control programs. As the program memory 4, a ROM or a RAM may be used. In the case in which a RAM is used, programs are loaded into the RAM from an external storage device or the like.

The bus 6 is also connected to a data memory 5 for storing various databases, such as a schedule database in which schedule data is stored, or a process information database in which data associated with process information generated in a process is stored. For example, a RAM is used as the data memory 5, and data is loaded into the RAM from an external nonvolatile storage device before processing is performed, and the data is read when it is needed during processing.

The bus 6 is used to transmit an address signal indicating a device to be controlled by the CPU 2 and a control signal by which to control a device. When data is transferred between devices, the bus 6 is also used.

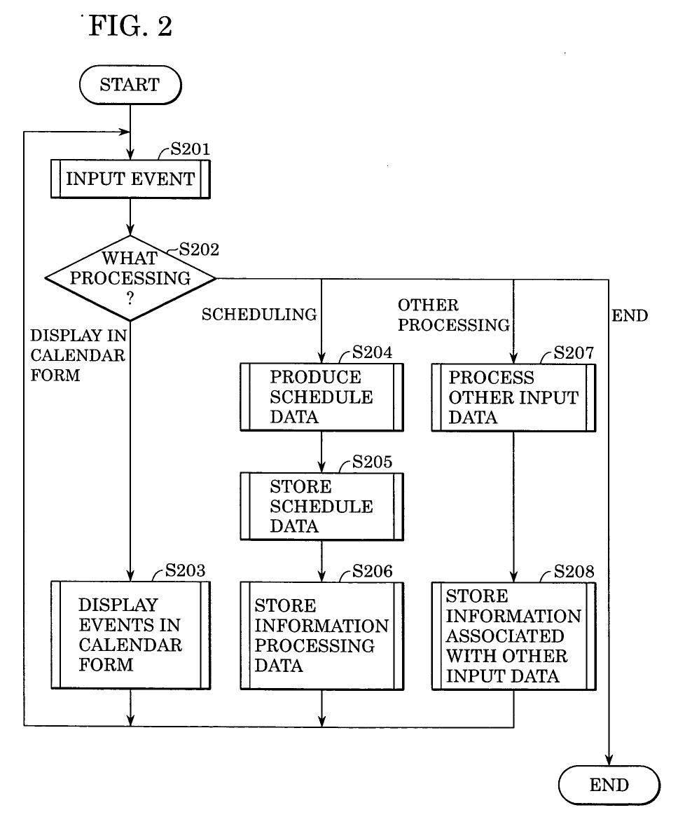

FIG. 2 is a flow chart showing an outline of a process performed by the information processing apparatus shown in FIG. 1, according to the first embodiment.

As shown in FIG. 2, the process performed by the information processing apparatus includes steps described below.

First, in step S201, an event/job input process is performed. In this event/job input process, an operation performed by a user and an occurrence of an event are detected and input.

Next, in step S202, a determination is made as to what type of process is specified in the event/job input process in step S201. In the case where it is determined that an “end command” was input, the process immediately ends. If it is determined that a “calendar form display” command was input, the process proceeds to step S203. In the case where it is determined that a “schedule create” command was input, the process proceeds to step S204. If it is determined that another command was input, the process proceeds to step S207.

Turning to step S203, data input in step S201 is displayed in a calendar form. When displaying of the data is completed, the process returns to step S201.

In step S204, schedule data is generated in accordance with an operation performed by the user. After the schedule data generation is completed, the process proceeds to step S205.

In step S205, the schedule data is stored in a schedule database. Thereafter, the process proceeds to step S206.

In step S206, a process information storage process is performed. More specifically, process information associated with the schedule is stored in a process information database. Thereafter, the flow returns to step S201 to repeat the process.

If a command other than “calendar form display” or “schedule create” was entered in step S201, flow proceeds to step S207. In step S207, the command inputted in step S201 is executed. Thereafter, the process proceeds to step S208.

In step S208, the process information processed in step S207 is stored in the process information database. For example, files (tabular files, document files, image files, etc.) processed or edited by a user are stored in relation to times at which files were processed or edited in the process information database. Thereafter, the flow returns to step S201 to repeat the process.

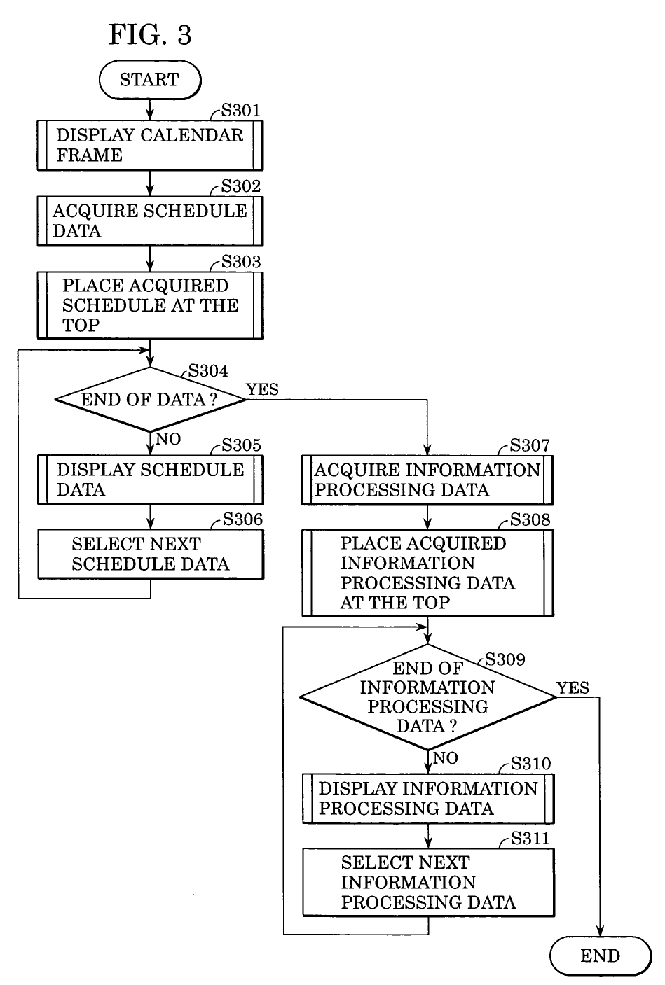

FIG. 3 is a flow chart showing the details of the calendar form display process (step S203) shown in FIG. 2.

The calendar form display process shown in FIG. 3 includes steps described below.

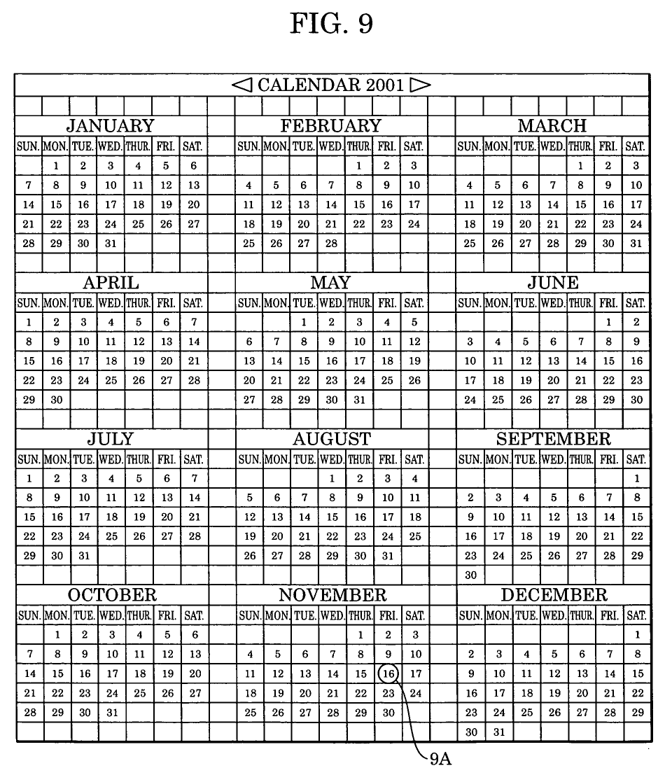

In step S301, a calendar frame in which to display the schedule data per one of formats shown in FIGS. 9 to 16 is displayed.

Next, in step S302, schedule data to be displayed in the calendar frame displayed in step S301 is acquired from the schedule database.

Then, in step S303, the schedule data acquired in step S302 is placed at the top of a schedule data set.

Flow then proceeds to step S304, where it is determined whether the schedule display process should end. If all schedule data has been displayed, it is determined that the schedule display process should end, and the flow proceeds to step S307. If it is determined that the process should not end, the flow proceeds to step S305.

Turning to step S305, schedule data is displayed in the calendar frame displayed in step S301.

Next, in step S306, the next schedule data is selected from the schedule data set. The process flow then returns to step S304 to repeat the process.

If all the schedule data has been displayed, then in Step S307, process information, other than the schedule data, to be displayed in the calendar frame displayed in step S301 is acquired.

Then, in step S308, initialization is performed such that the process information to be displayed, acquired in step S307, is placed at the top of a process information set.

Next, in step S309, it is determined whether the process should end. In the case where it is determined that the process should end, the process immediately ends. In the case where it is determined that the process should not end, the flow proceeds to step S310.

In step S310, the process information other than the schedule data is displayed at a correct position (i.e., at a corresponding date/time position) in the calendar frame displayed in the calendar frame display step.

Then, in step S311, next process information is selected, and the flow returns to step S309 to repeat the process.

When the process is completed for all process information, and if it is determined in step S309 that the process should end, the process ends.

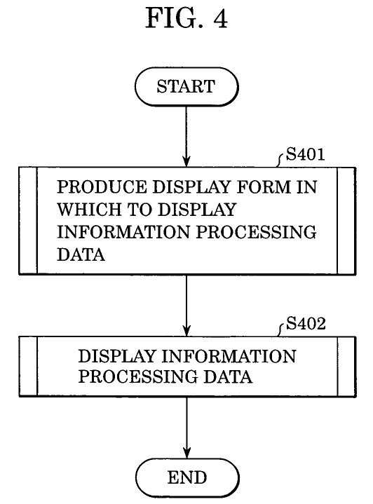

FIG. 4 is a flow chart showing the details of the process information display process (step S206) shown in FIG. 2.

The process information display process shown in FIG. 4 includes steps described below.

First, in step S401, a process information indicator indicating process information is generated.

Next, in step S402, the process information is displayed at a correct position.

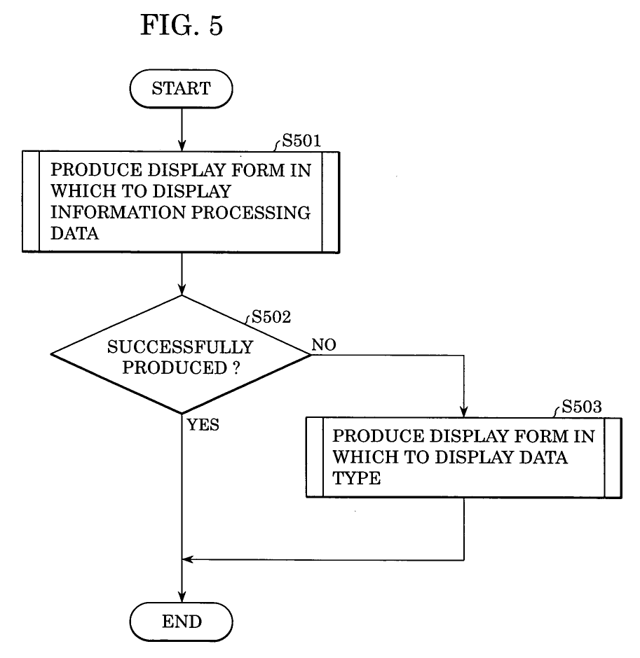

FIG. 5 is a flow chart showing the details of the process information indicator generation step (step S401) shown in FIG. 4.

The process information indicator generation process shown in FIG. 5 includes steps described below.

In step S501, a process information indicator, such as a thumbnail icon corresponding to a process information file, indicating process information is produced based on the process information.

Next, in step S502, a determination is made whether the generation of the process information indicator indicating the process information data in step S501 is successfully produced. If it is determined that the process information indicator is successfully produced, the process ends. If, however, it is determined that the process information indicator is not successfully produced, the process proceeds to step S503.

In step S503, a data type indicator, such as an icon indicating the data type of a process information file, corresponding to the data type of the process information is produced. Following this step, the process ends.

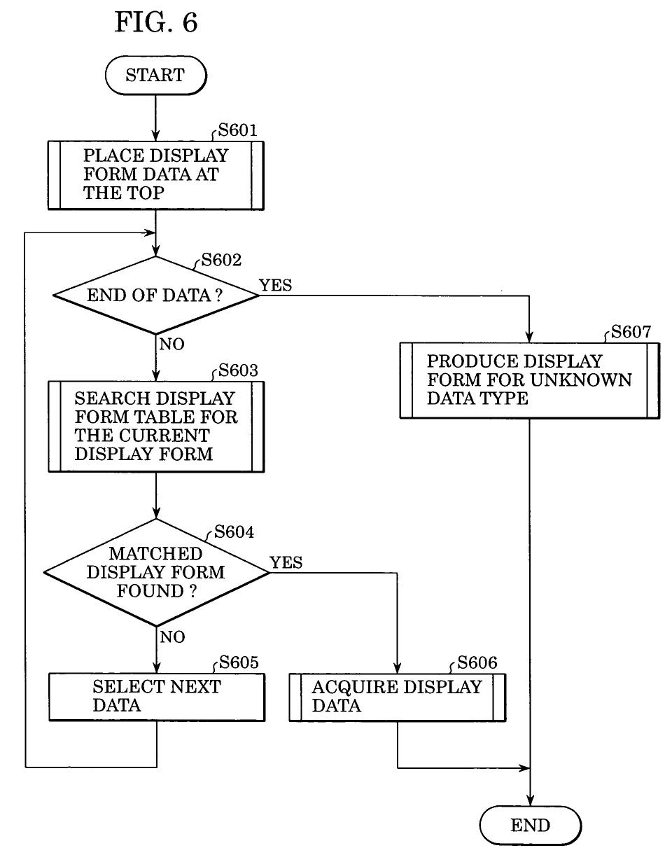

FIG. 6 is a flow chart showing the details of the data type indicator generation process (step S503).

The data type indicator generation process shown in FIG. 6 includes steps described below.

First, in step S601, initialization is performed such that a data type described at the top of the data type correspondence table is acquired.

Then, in step S602, it is determined whether the end of the data type correspondence table has been reached. If it is determined that the end of the data type correspondence table has been reached, the flow proceeds to step S607. However, if it is determined that the end of the data type correspondence table has not been reached, the flow proceeds to step S603.

In step S603, the data type of the process information is compared with the data type acquired from the data type correspondence table.

In step S604, a determination is made whether the data type of the process information is the same as the data type acquired from the data type correspondence table. If it is determined that the data is the same, the process proceeds to step S606. If, however, it is determined that the data is not the same, the process proceeds to step S605.

In step S605, a next data type is acquired from the data type correspondence table, and the flow returns to step S602 to repeat the process.

In step S606, a data type indicator corresponding to the data type acquired from the data type correspondence table is generated, and the process ends.

In step S607, a data type indicator indicating an unknown data type is generated for the process information. Thereafter, the process ends.

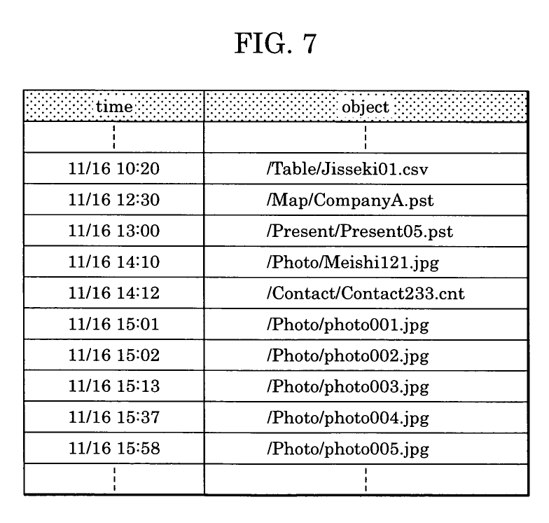

FIG. 7 shows a table showing an example of the process information database in which process information to be subjected to the process information acquisition step (step S307) in FIG. 3 is stored.

Each process information data stored in the process information database includes data indicating a time and an object. In the process information acquisition step (step S307), process information data whose time data is equal to a designated time is acquired from the process information database. The time data indicates a date depicted as year/month/day/hour by which it is possible to specify a position at which to display the process information in the calendar view form.

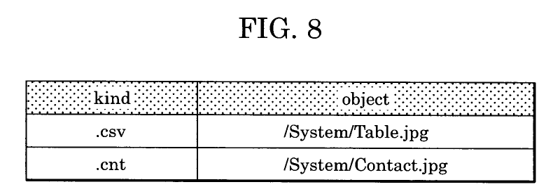

FIG. 8 shows an example of the data type correspondence table that is referred to in the data type indicator generation process (step S503) in FIG. 5. Each data defined in the data type correspondence table includes data indicating data type (kind) and an object. In the data type indicator generation process, a data type indicator corresponding to a data type is selected from the data type correspondence table.

FIGS. 9 to 16 show examples of calendar forms displayed in the calendar form display process (step S203) in FIG. 2.

FIG. 9 shows an example of a yearly schedule calendar including twelve months of the year. In the calendar, a day on which there is some scheduled event/job which may have associated process information is marked with reference numeral 9A. Specifically, the 16th day of November is marked to indicate that there is some scheduled event/job which may have associated process information.

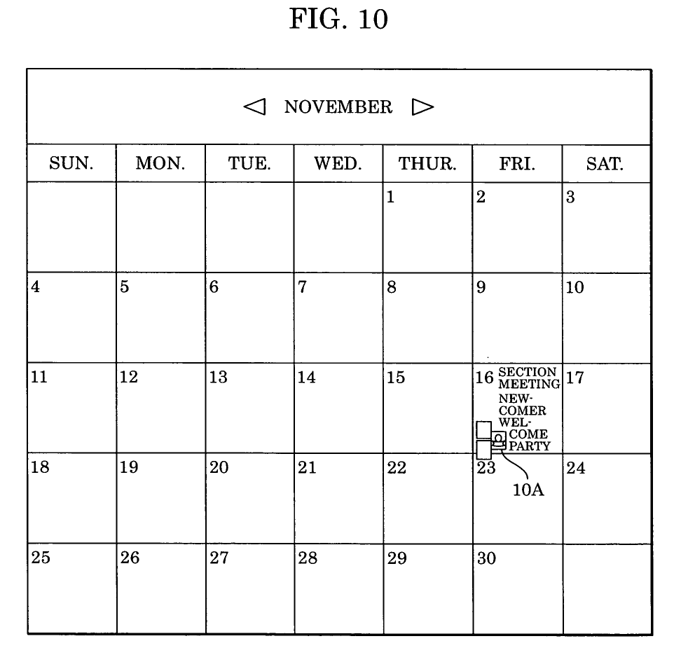

FIG. 10 shows an example of a monthly schedule view form in which days of a month are displayed in the form of a calendar, and a brief description of a schedule is displayed in a day box corresponding to a day on which there is some scheduled event/job which may have associated process information. In the specific example shown in FIG. 10, a schedule of November is displayed. In a box of the 16th day of November, a description/indication 10A is displayed to indicate that a “section meeting” and a “newcomer welcome party” are scheduled, and that there is process information.

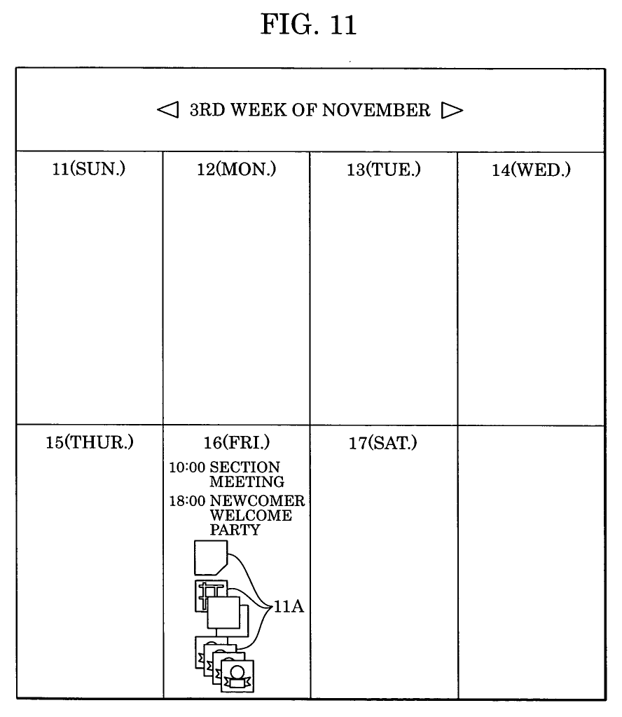

FIG. 11 shows an example of a weekly schedule view form in which days of a week are displayed in two rows, and a brief description of scheduled events/jobs and their times is displayed in a day box corresponding to a day on which there is some scheduled event/job which may have associated process information. In the specific example shown in FIG. 11, a schedule for the 3rd week of November is displayed. In a box of the 16th day of November, a description/indication 11A is displayed to indicate that a “section meeting” is scheduled at 10:00 and a “newcomer welcome party” is scheduled at 18:00 and that there is process information.

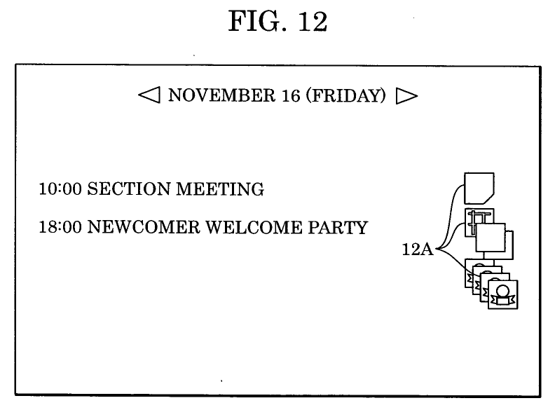

FIG. 12 shows an example of a daily schedule view form in which a brief description of events/jobs, times thereof, and an indication of presence of process information are displayed. In the specific example shown in FIG. 12, a schedule of the 16th day of November is displayed. In this schedule form, a description/indication 12A is displayed to indicate that a “section meeting” is scheduled at 10:00 and a “newcomer welcome party” is scheduled at 18:00 and that there is process information.

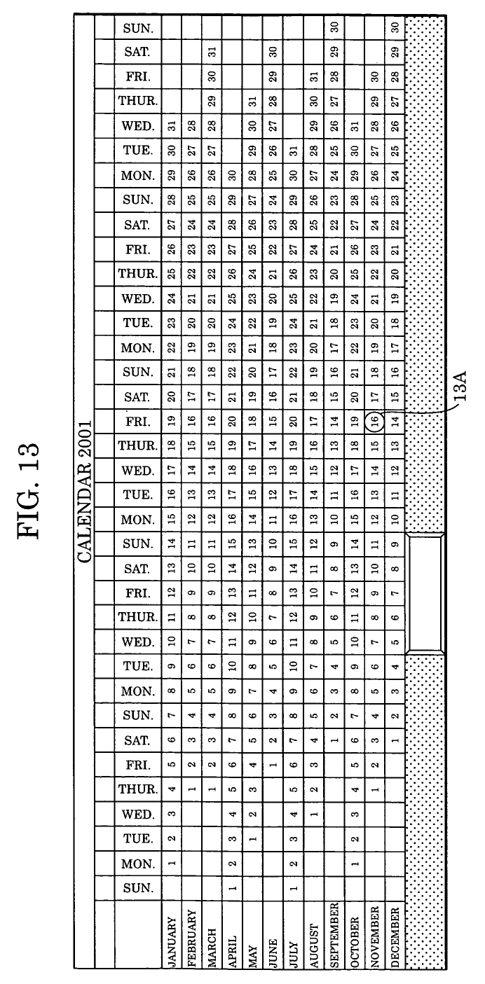

FIG. 13 shows an example of a yearly schedule view form in which days of each month are displayed in a horizontal row, and a day on which there is some scheduled event/job which may have associated process information is marked with reference numeral 13A. In the example shown in FIG. 13, the 16th day of November is marked to indicate that there is some scheduled event/job which has associated process information.

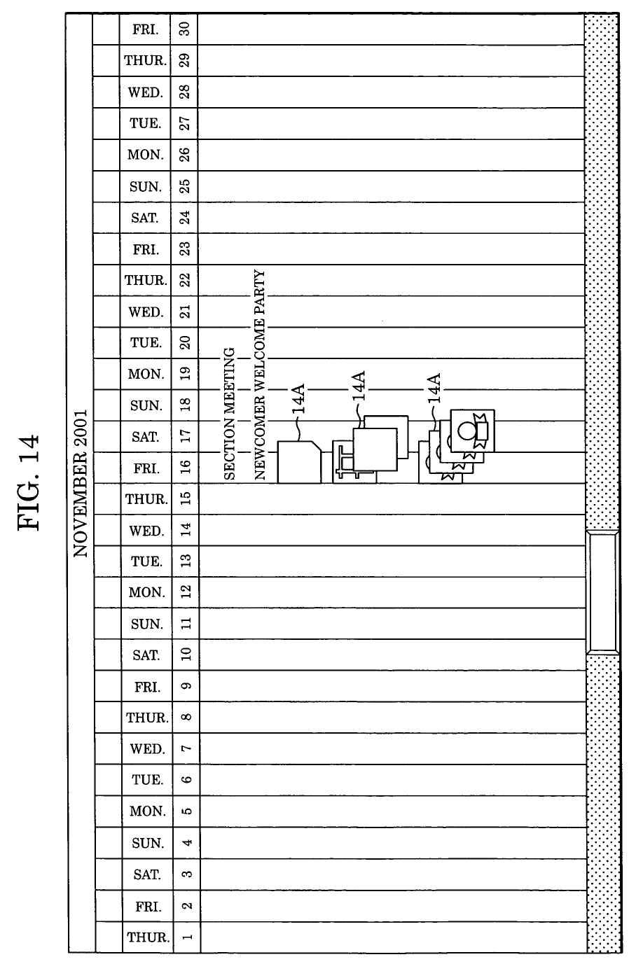

FIG. 14 shows an example of a time-month schedule view form in which days of a month are displayed in a single horizontal row, and a brief description of a schedule is displayed in a day box corresponding to a day on which there is some scheduled event/job which may have associated process information. In the specific example shown in FIG. 14, a schedule of November 2001 is displayed. In a column of the 16th day of November, a description/indication 14A is displayed to indicate that a “section meeting” is scheduled that there is process information. In a column of the 17th day, a description/indication 14A is displayed to indicate that a “newcomer welcome party” is scheduled and that there is process information.

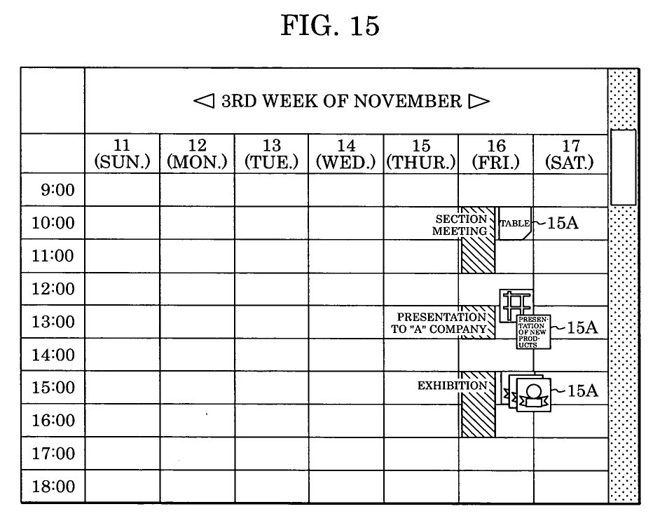

FIG. 15 shows an example of a time-week schedule view form in which days of a week are displayed in a horizontal row, and times of each day are displayed in a vertical direction. In this form, a description/indication of an event/job 15A is displayed in rows corresponding to a scheduled time and in a column corresponding to a scheduled day.

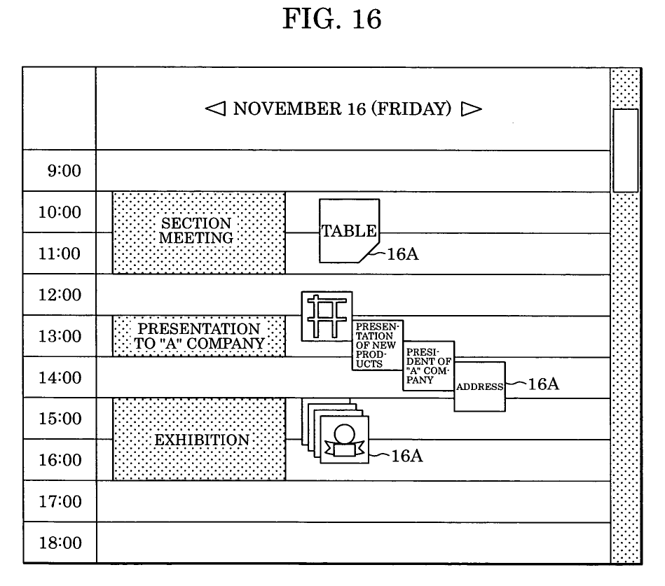

FIG. 16 shows an example of a time-day schedule view form in which a brief description of events/jobs, times thereof, and an indication of presence of process information are displayed. In the specific example shown in FIG. 16, a schedule of the 16th day of November is displayed. More specifically, a description/indication 16A is displayed to indicate that a “section meeting” is scheduled at 10:00 to 11:00 and there is an associated “table” as process information, a “presentation to A company” is scheduled at 13:00 and there are a map, a new product presentation document, and an address page as process information, and attendance to an “exhibition” is scheduled at 15:00 to 16:00 and there is an image as process information.

In the first embodiment, as described above, by simultaneously displaying a schedule and information associated with data file processed by a user in a single calendar form, it becomes possible to effectively retrieve data based on the schedule.

### Second Embodiment

A process performed by the information processing apparatus of FIG. 1 in accordance with a second embodiment is described below with reference to FIG. 2.

In this second embodiment, a schedule and process information is displayed in a calendar form in a similar manner except that the type of process information (specified by a user) is displayed.

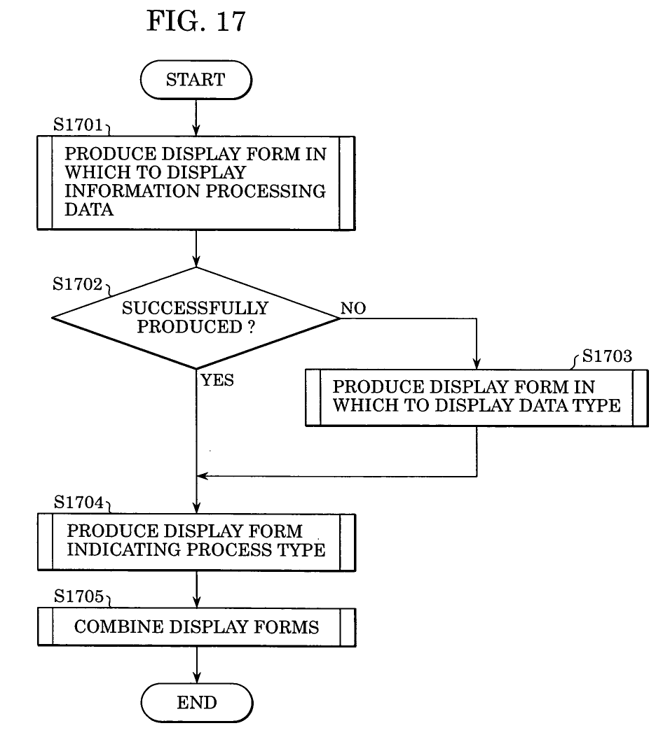

FIG. 17 is a flow chart showing a process information indicator generation process according to the second embodiment.

As shown in FIG. 17, in the process information indicator generation process according to the second embodiment, after steps S1701 to S1703, which are similar to steps S501 to S503 shown in FIG. 5, are performed, the following steps described below are performed.

In step S1704, an indicator, (such as an icon indicating generation, update, transmit, receive, or warning, indicating the type of a process specified by a user or an event that has occurred is produced.

Then, in step S1705, the indicator produced in step S1704 is combined with a data indicator produced in the data indicator generation step (step S1701) or an data type indicator produced in the data type indicator generation step (step S1703).

In a case in which the indicator in the process type indicator generation step (step S1704) is not produced, the indicator produced in the data type indicator generation step (step S1703) is employed.

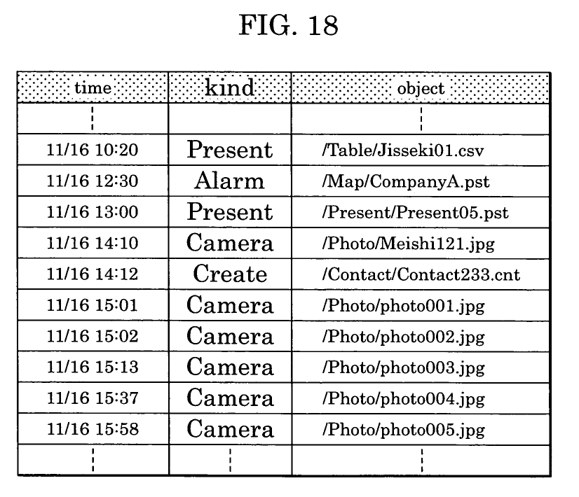

FIG. 18 shows a table depicting an example of the process information database in which process information to be subjected to the process information acquisition step (similar to step S307 in the first embodiment) is stored according to the second embodiment. Each process information data stored in the process information database includes data indicating the time and the object, which is similar to process information data according to the first embodiment, and further includes data indicating the type (kind) of process information. In the process information acquisition step, process information data whose time data is equal to a designated time is acquired from the process information database.

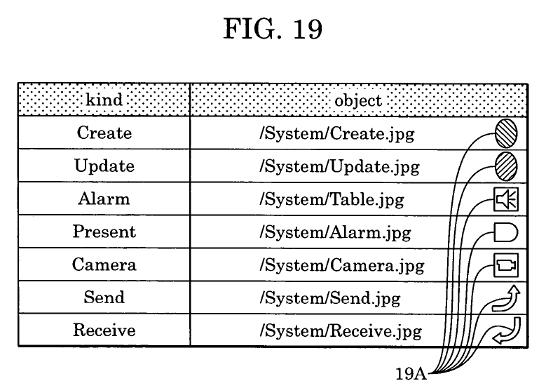

FIG. 19 shows an example of a data type correspondence table that is referred to in the process type indicator generation step (step S1704). Each data defined in the data type correspondence table includes data indicating data type (kind) and an object. In the process type indicator generation process, an indicator corresponding to a designated type is selected from the data type correspondence table, and the indicator in the form of an icon 19A indicating the data type of each object is displayed.

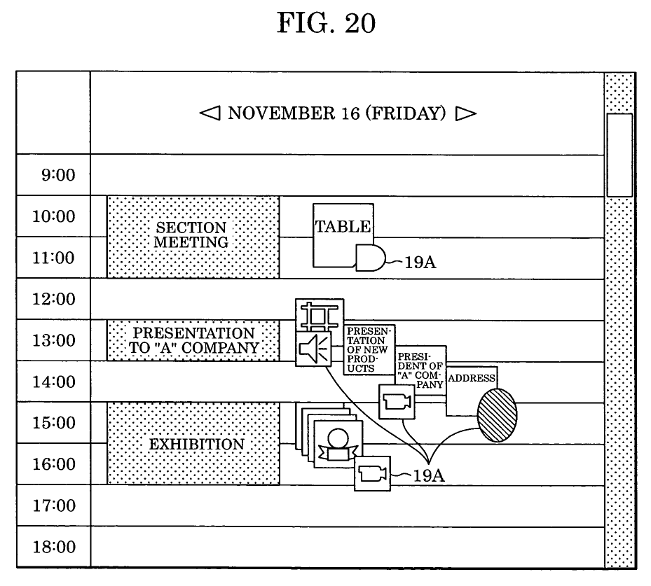

FIG. 20 shows an example of a time-day schedule view form according to the second embodiment, corresponding to that shown in FIG. 16 according to the first embodiment. In this time-day schedule view, in addition to descriptions/indicators displayed in corresponding time positions as in the first embodiment, indicators 19A indicating process types are displayed.

Thus the second embodiment provides, in addition to the advantages provided by the first embodiment, an advantage that an indicator indicating the type of a process or an event is displayed in a superimposed fashion in the calendar form. Thus it is possible to easily and quickly retrieve data, based on a schedule and a process type.

### Third Embodiment

A process performed by the information processing apparatus of FIG. 1 in accordance with a third embodiment is described below.

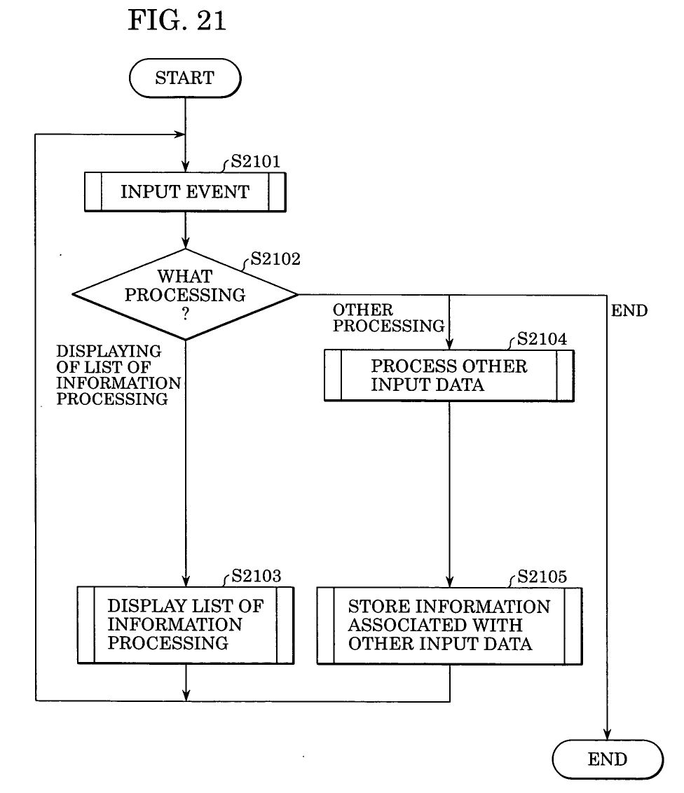

FIG. 21 is a flow chart showing an outline of the process according to the third embodiment.

The third embodiment includes the steps of the first embodiment and the second embodiment, and further includes the process of displaying information in a view form specified by a user other than the calendar view form.

As shown in FIG. 21, the process according to the third embodiment includes steps described below.

First, in step S2101, an event/job input process is performed in a similar manner to step S201 in the first embodiment. In this event/job input process, an operation performed by a user and an occurrence of an event are detected and input.

Next, in step S2102, a determination is made regarding what kind of process is specified in the event/job input process in step S2101. In the case where it is determined that an “end command” was input, the process immediately ends. If it is determined that a “process information list display” command was input, the process proceeds to step S2103. If it is determined that another command was input, the process proceeds to step S2104.

Turning to step S2103, process information is displayed, and then the flow returns to step S2101 to repeat the process.

Steps S2104 and S2105 are respectively similar to steps S207 and S208 in the first embodiment. That is, after process information is processed in step S2104, the process information is stored in the process information database in step S2105. After completion of step S2105, the flow returns to step S2101 to repeat the process.

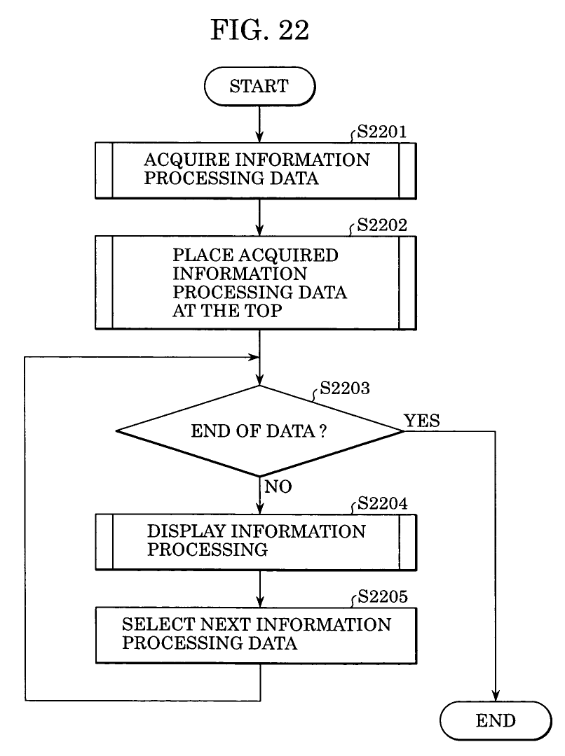

FIG. 22 is a flow chart showing the details of the step of displaying a process information list (step S2103) shown in FIG. 21.

The process of displaying the process information list, shown in FIG. 22, includes steps described below.

Initially, in step S2201, process information to be displayed is acquired.

Then, in step S2202, initialization is performed such that the process information acquired in step S2201 is placed at the top of a process information set.

In step S2203, it is determined whether the process of displaying the process information list should end. In the case where it is determined that the process should end, the process immediately ends. If, however, it is determined that the process should not end, the flow proceeds to step S2204.

In step S2204, the process information is displayed at a correct position.

Finally, in step S2205, next process information is selected from the process information set, and the flow returns to step S2203 to repeat the process.

When the process is completed for all process information to be displayed, and if it is determined in step S2203 that the process should end, the process ends.

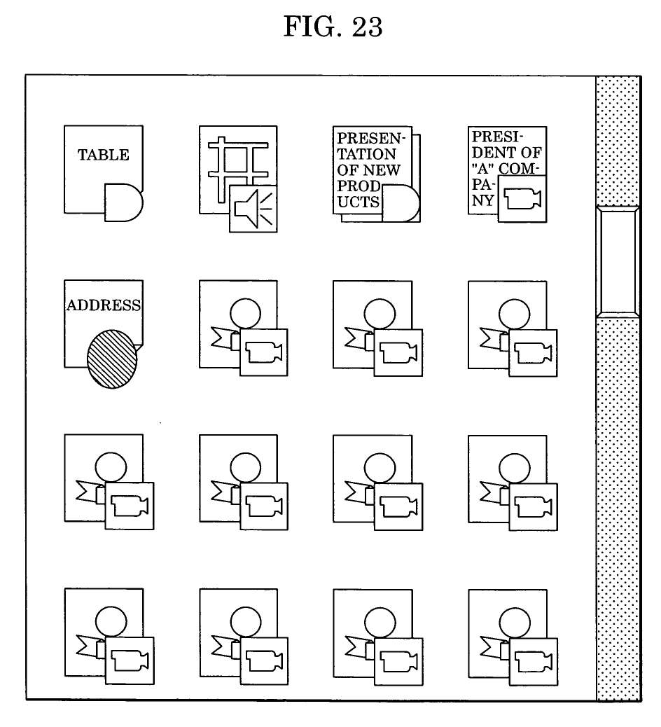

FIG. 23 shown an example of the process information list displayed in the process information list display step shown in FIG. 22.

In the example depicted in FIG. 23, icons indicating process information are displayed in the form of a two-dimensional array instead of in a calendar form. As in the second embodiment, an icon indicating a process type is superimposed on each indicator of process information.

In the third embodiment, as described above, icons are displayed in the form of a two-dimensional array such that data corresponding to an operation performed by a user, an event that has occurred, and/or a schedule is displayed in a manner in which the data type and the process type are explicitly indicated. This makes it possible to easily and quickly retrieve data that was processed or is to be processed. That is, according to the present embodiment, data can be displayed in a view form other than the calendar view form so that the process type is explicitly indicated, making it is possible to easily and quickly retrieve data based on the process type.

### Fourth Embodiment

A process performed by the information processing apparatus of FIG. 1 in accordance with a fourth embodiment is described below.

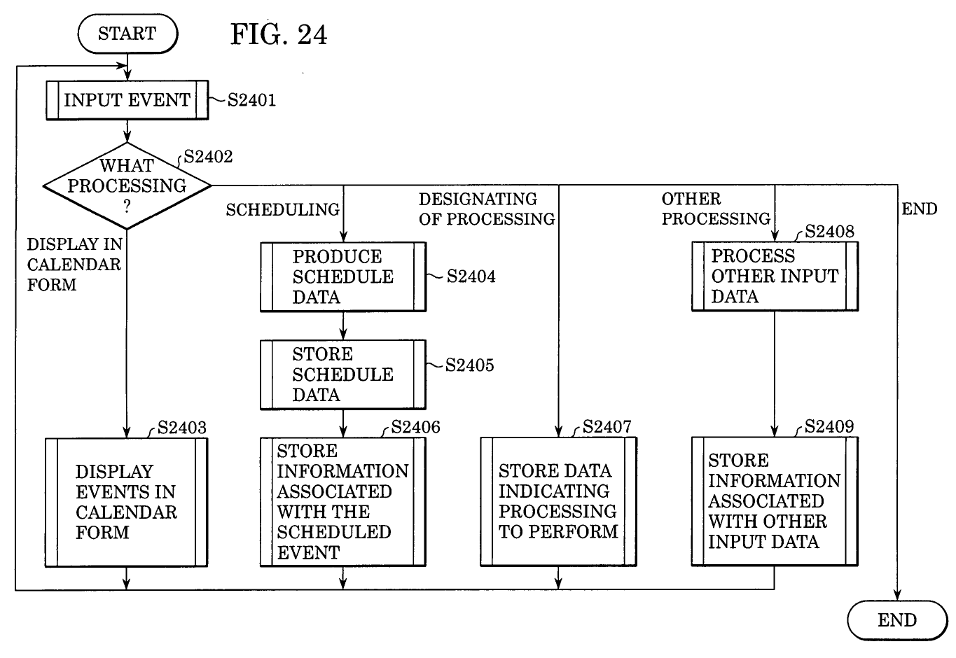

FIG. 24 is a flow chart showing an outline of a process according to the fourth embodiment.

The fourth embodiment includes a process of specifying (limiting) process information, in addition to the process of the second embodiment.

As shown in FIG. 24, the process according to the fourth embodiment includes steps described below.

First, in step S2401, an event/job input process is performed in a similar manner to step S201 in the first embodiment. In this event/job input process, an operation performed by a user and an occurrence of an event are detected and input.

Next, in step S2402, a determination is made regarding what kind of process is specified in the event/job input process in step S2401. As in step S202 in the first embodiment, if it is determined that an “end command” was input, the process immediately ends. In the case where it is determined that a “calendar form display” command was input, the process proceeds to step S2403, which corresponds to step S203 in the first embodiment. In the case where it is determined that a “schedule create” command was input, steps S2404 to S2406, which correspond to steps S204 to S206 in the first embodiment, are performed. If it is determined that another command was input, steps S2408 and S2409, which correspond to steps S207 and S208 in the first embodiment, are performed. In this fourth embodiment, the decision step S2402 has an additional branch. That is, when it is determined that a “process type designation” command was input, the process proceeds to step S2407.

Steps S2404 to S2406, S2408, and S2409 are performed in a similar manner their corresponding steps in the first embodiment, and thus a description thereof is omitted.

Turning to step S2403, data input in step S2401 is displayed in a calendar form. When displaying of the data is completed, the process returns to step S2401.

In step S2407, a determination is made regarding what type of process to be displayed was specified by a user, and data indicating the specified type is stored. Thereafter, the flow returns to step S2401 to repeat the process.

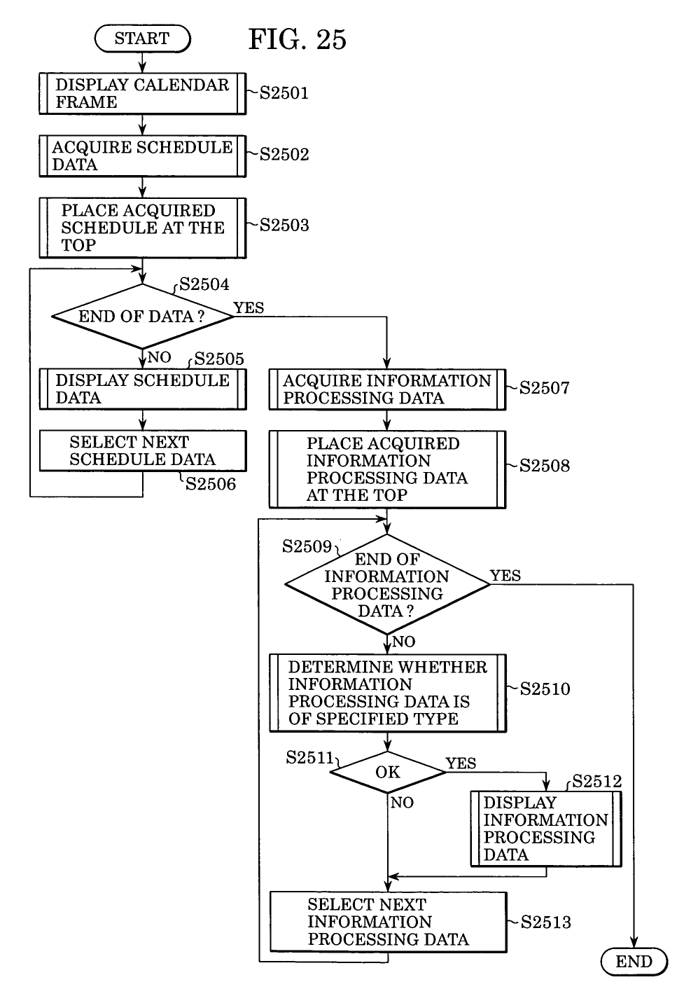

FIG. 25 is a flow chart showing the details of the calendar form display process (step S2403) shown in FIG. 24.

In the calendar form display process shown in FIG. 25, steps S2501 to S2508 are performed in a similar manner to steps S301 to S308 in the first embodiment. The following steps thereafter are performed as described below.

In step S2509, it is determined whether the process should end. In the case in which it is determined that the process should end, the process immediately ends. If, however, it is determined that the process should not end, the flow proceeds to step S2510.

In step S2510, a determination is made regarding whether process information of interest is process information designated to be displayed in the process type designation process (step S2407).

Next, in step S2511, a determination is made whether the determination in step S2510 indicates that the process information of interest should be displayed. If it is determined that the process information of interest should be displayed, the process proceeds to step S2512. Otherwise, the process proceeds to step S2513 without displaying the process information.

In step S2512, the process information is displayed. More specifically, the process information to be displayed, other than the schedule data, is acquired and displayed at a correct position in the calendar frame displayed in the calendar frame display process (step S2403).

In step S2513, next process information to be examined is acquired, and the flow returns to step S2509 to repeat the process.

When the process is completed for all process information, and if it is determined in step S2509 that the process should end, the process ends.

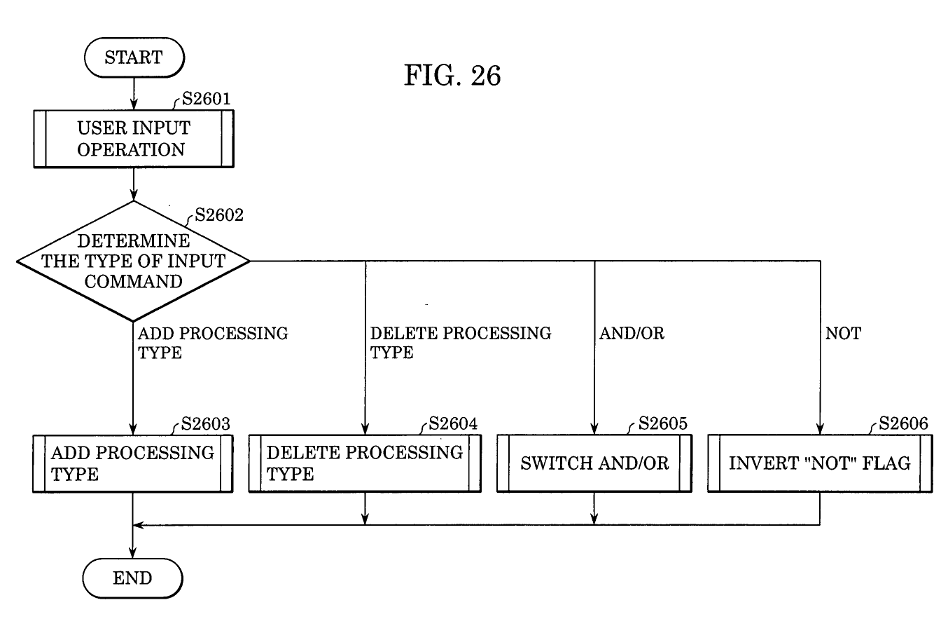

FIG. 26 is a flow chart showing the details of the process information type designation process (step S2407).

The process information type designation process shown in FIG. 26 includes steps described below.

Initially, in step S2601, an input operation is performed by a user.

Next, in step S2602, a determination is made regarding what type of input operation was performed. If it is determined that a “process type add” command to add a process type to be displayed was input, the process proceeds to step S2603. In a case in which it is determined that a “process type delete” command to delete a process type from process types to be displayed was input, the process proceeds to step S2604. In a case in which it is determined that a “AND/OR switch” command to switch “AND/OR” designation in terms of process types specified to be displayed was input, the process proceeds to step S2605. In a case in which it is determined that a “NOT designation” command to invert the designation in terms of displaying process types, the process proceeds to step S2606.

Turning to step S2603 a process type is added to process type designation information, which will be described later.

In step S2604, a process type is deleted from the process type designation information.

In step S2605, the AND/OR designation defined in the process type designation information is switched such that if AND is currently designated, the designation is switched to OR, while if OR is currently designated, the designation is switched to AND.

Finally, in step S2606, the designation in terms of NOT defined in the process type designation information is switched such that if the NOT designation is currently set to “true”, the designation is switched to “false” while if the NOT designation is currently set to “false”, the designation is switched to “true”.

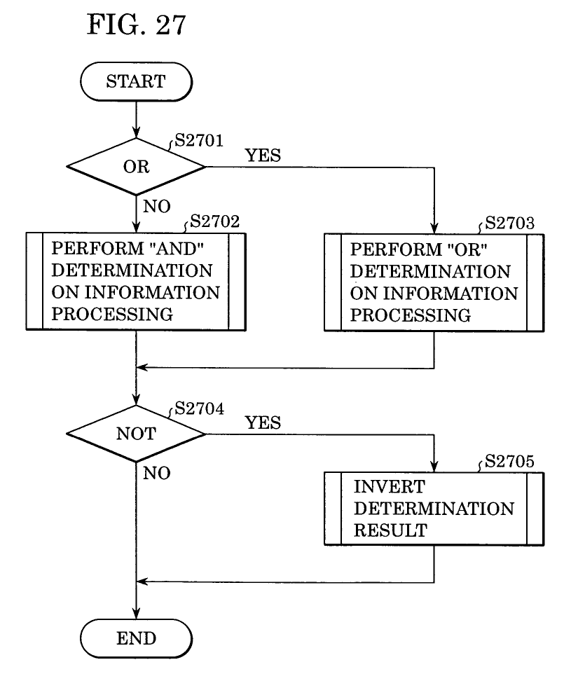

FIG. 27 is a flow chart showing the details of the process of determining what information should be displayed (step S2510).

This process of determining what information should be displayed includes steps described below.

First, in step S2701, the process type designation information is examined to determine whether “OR” is designated. If “OR” is designated, the process proceeds to step S2703, otherwise (i.e., if “AND” is designated) the process proceeds to step S2702.

In step S2702, a determination is made whether a process type satisfies all process types designated in the process type designation information.

In step S2703, a determination is made whether a process type satisfies one of process types designated in the process type designation information.

Following the results of the determination in either step S2702 or step S2703, flow proceeds to step S2704, where the process type designation information is examined to determine whether “NOT” is designated. If “NOT” is designated, the process proceeds to step S2705, otherwise the process ends.

In step S2705, the determination made in step S2702 or S2703 is inverted. That is, information designated to be displayed is re-designated not to be displayed, while information designated not to be displayed is re-designated to be displayed. After completion of step S2705, the process ends.

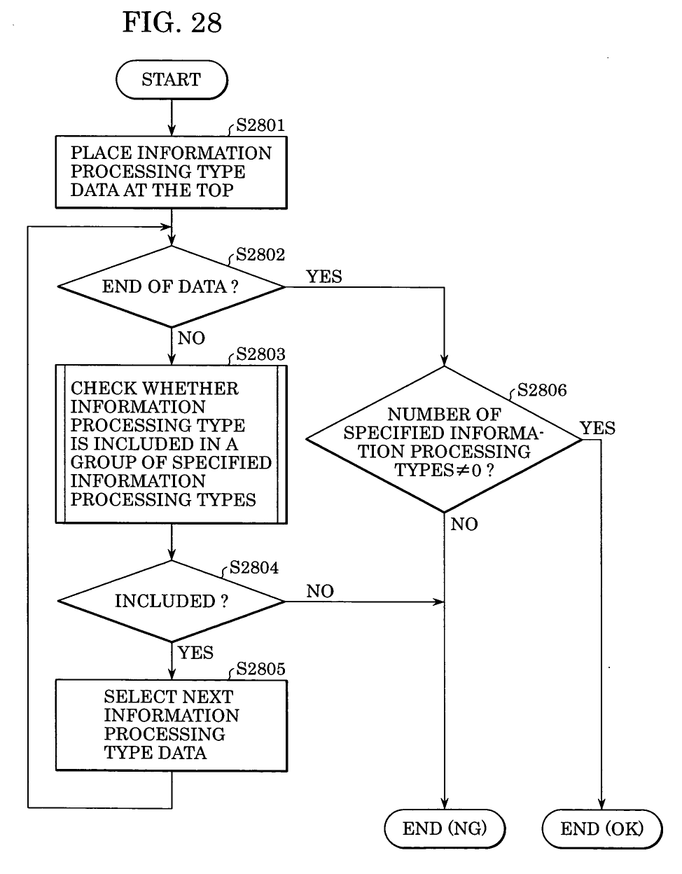

FIG. 28 is a flow chart showing the details of the AND determination step (step S2702).

The AND determination step shown in FIG. 28 includes steps described below.

In step S2801, initialization is performed such that a process type is acquired from the top of the process type list defined in the process type designation information.

Then, in step S2802 it is determined whether the end of the process type list has been reached. If it is determined that the end of the process type list has been reached, the flow proceeds to step S2806, otherwise the flow proceeds to step S2803.

In step S2803, the process type of process information of interest is compared with the process type acquired from the process type list defined in the process type designation information.

Next, in step S2804, if the comparison in step S2803 indicates that the process type of information of interest is different from the process type acquired from the process type list defined in the process type designation information, it is determined that the process information of interest is not process information to be displayed, and the process ends (END (NG)). If the process type is the same as that acquired from the process type list defined in the process type designation information, the process proceeds to step S2805.

In step S2805, a next process type is acquired from the process type list, and the flow returns to step S2802 to repeat the process.

In step S2806, if the number of process types included in the process type list designated in the process type designation information is equal to 0, it is determined that there is no process information to be displayed, and the process ends (END(NG)). If, on the other hand, the number of process types included in the process type list is not equal to 0, the process information of interest satisfies all designated process types, it is determined that the process information of interest is process information to be displayed, and the process ends (END(OK)). END (OK) means that there is process information to be displayed.

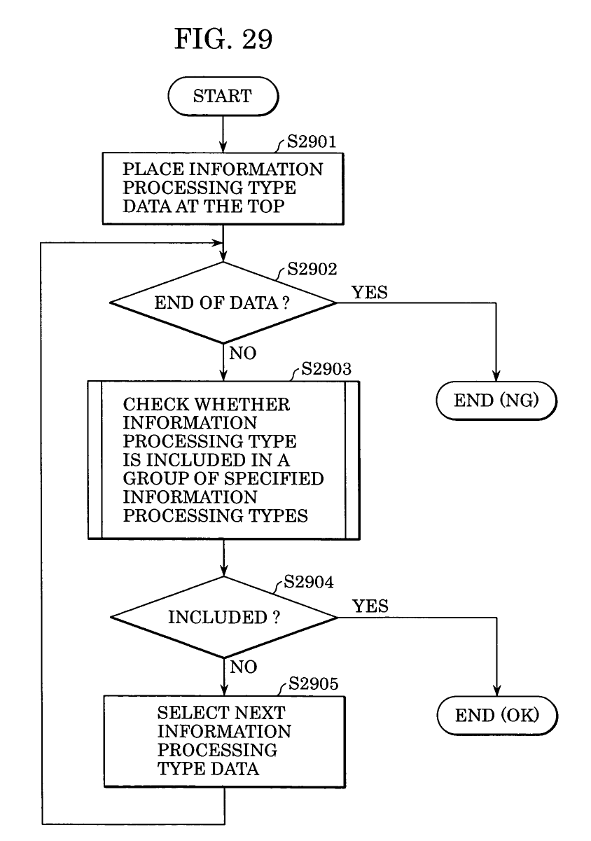

FIG. 29 is a flow chart showing the details of the OR determination process (step S2703).

The OR determination process shown in FIG. 29 includes steps described below.

First in step S2901, initialization is performed such that a proceeds type is acquired from the top of the process type list defined in the process type designation information.

Then, in step S2902, it is determined whether the end of the process type list has been reached. In the case where it is determined that the end of the process type list has been reached, the process immediately ends (END(NG)). If, however, it is determined that the end of the process type list has not been reached, the flow proceeds to step S2903.

Next, in step S2903, the process type of process information of interest is compared with the process type acquired from the process type list defined in the process type designation information.

In step S2904, if the comparison in step S2903 indicates that the process type of process information of interest is different from the process type acquired from the process type list defined in the process type designation information, the process proceeds to step S2905. Conversely, if the process type of process information of interest is the same as the process type acquired from the process type list defined in the process type designation information, it is determined that the process information of interest is process information that should be displayed, and the process ends (END(OK)).

In step S2905, a next process type is acquired from the process type list, and the flow returns to step S2902 to repeat the process.

When the process is completed for all process types, and if it is determined in step S2902 that the process should end, it is determined that there is no process information to be displayed, and the process ends.

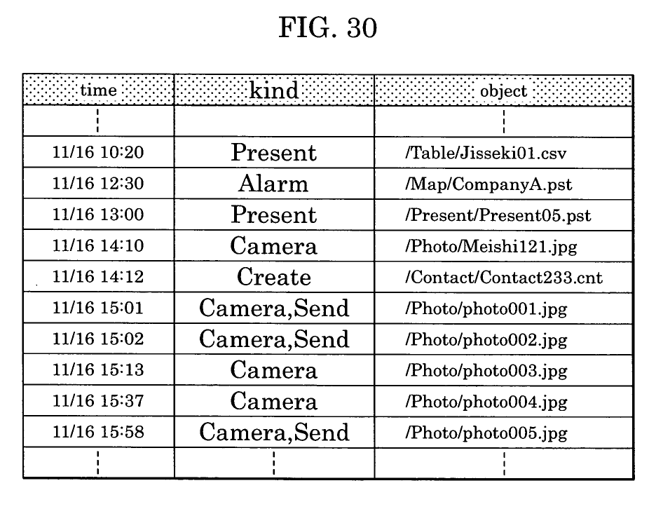

FIG. 30 shows a table depicting an example of the process information database in which process information to be subjected to the process information acquisition step (step S2507) in FIG. 25 is stored.

Each process information data stored in the process information database includes data indicating a time, a type, and an object. In the process information acquisition step (step S2507), a piece of process information whose time data is equal to a designated time is acquired from the process information database. Note that although in the process information database according to the second embodiment shown in FIG. 18, only one process type is described in the “type” (kind) field, the fourth embodiment allows a plurality of process types to be described in the “type” (kind) field.

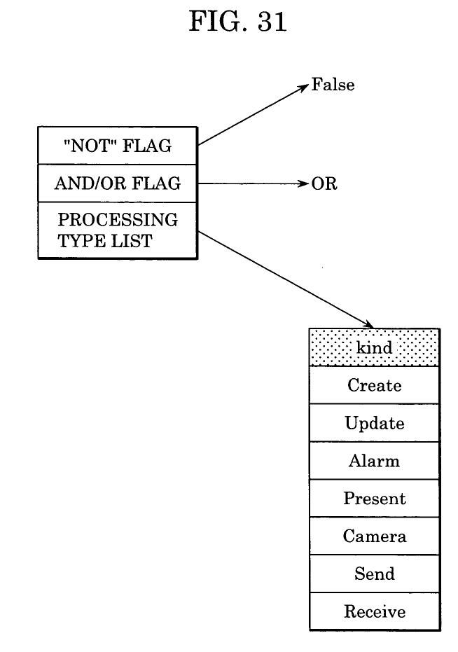

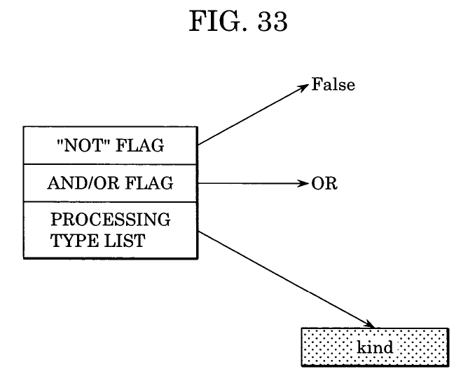

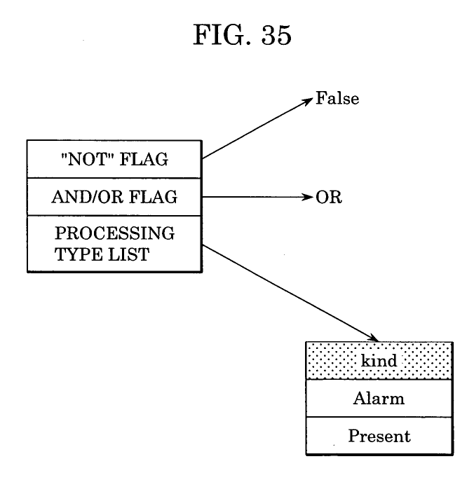

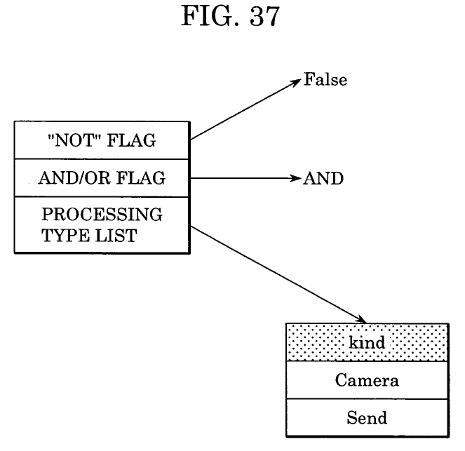

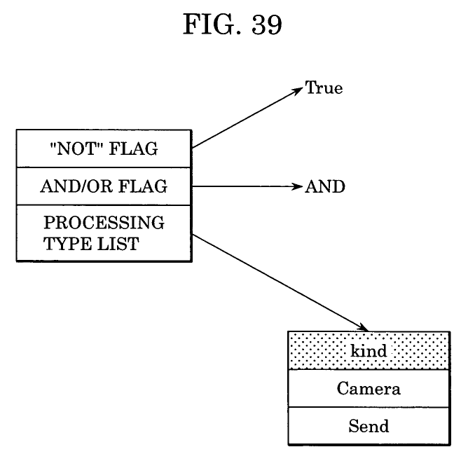

FIG. 31, FIG. 33, FIG. 35, FIG. 37, and FIG. 39 show examples of process type designation information that is subjected to the process type designation process, and the process of determining whether to display process information. The process type designation information includes a “NOT” flag, an “AND/OR” flag, and a process type list.

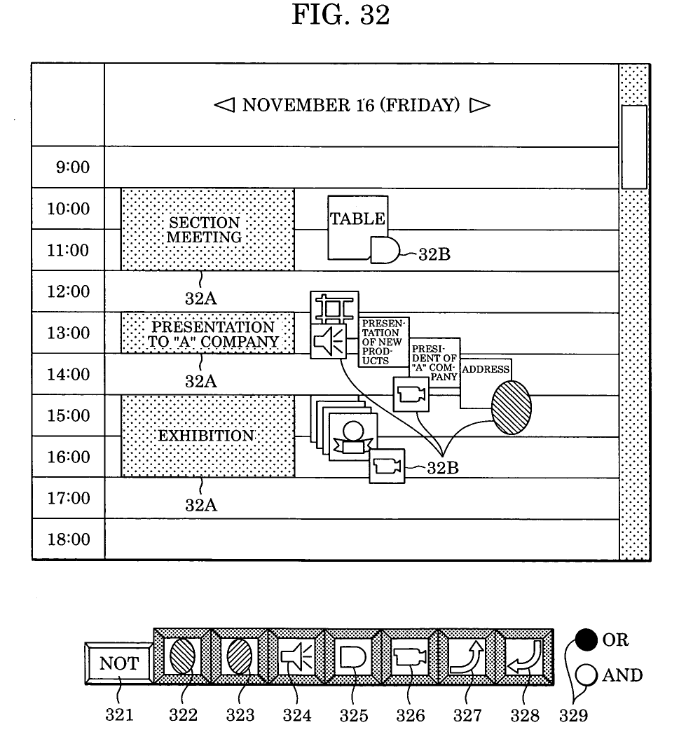

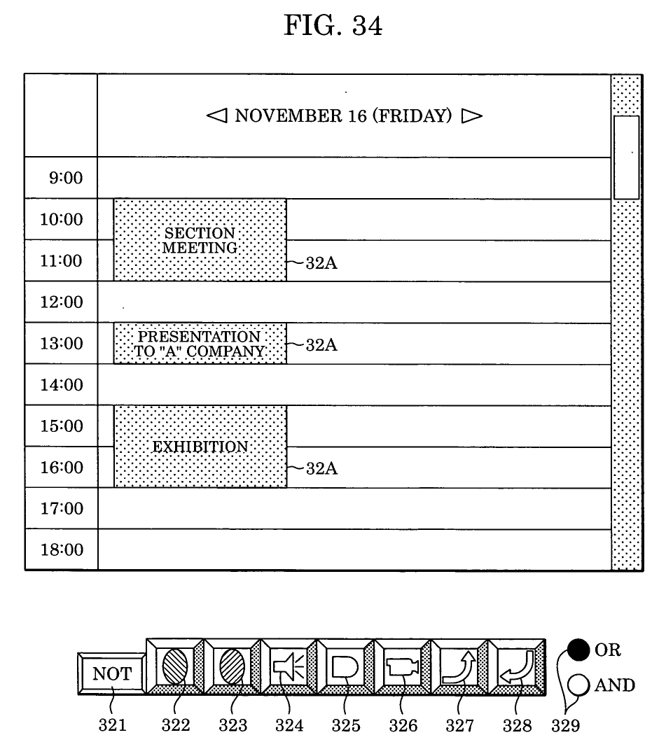

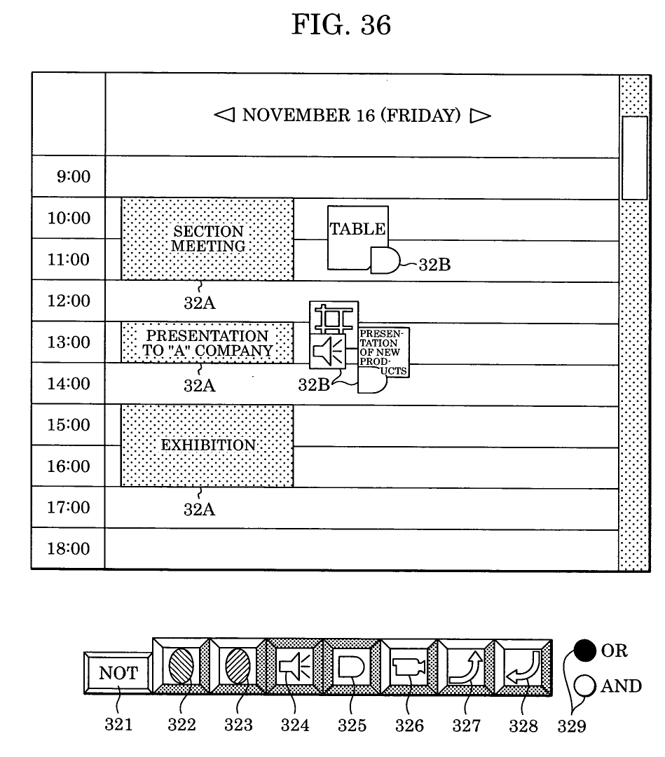

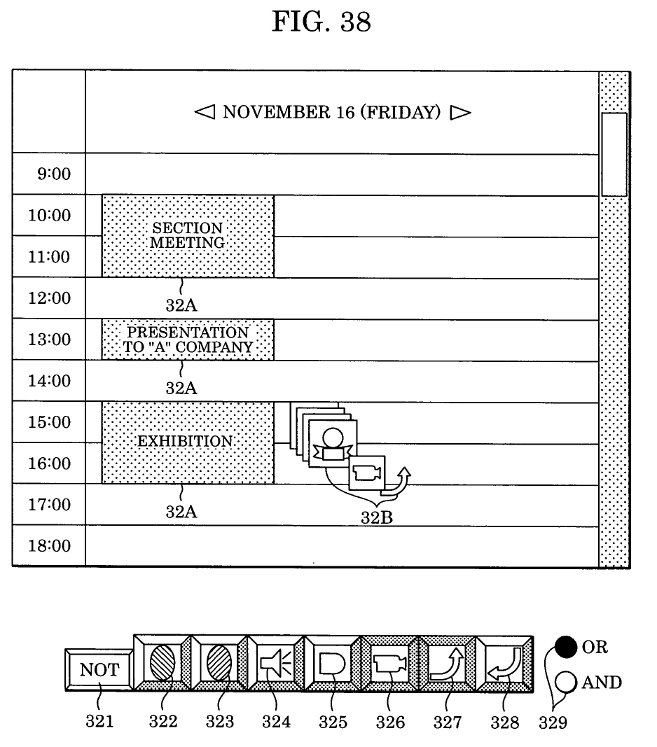

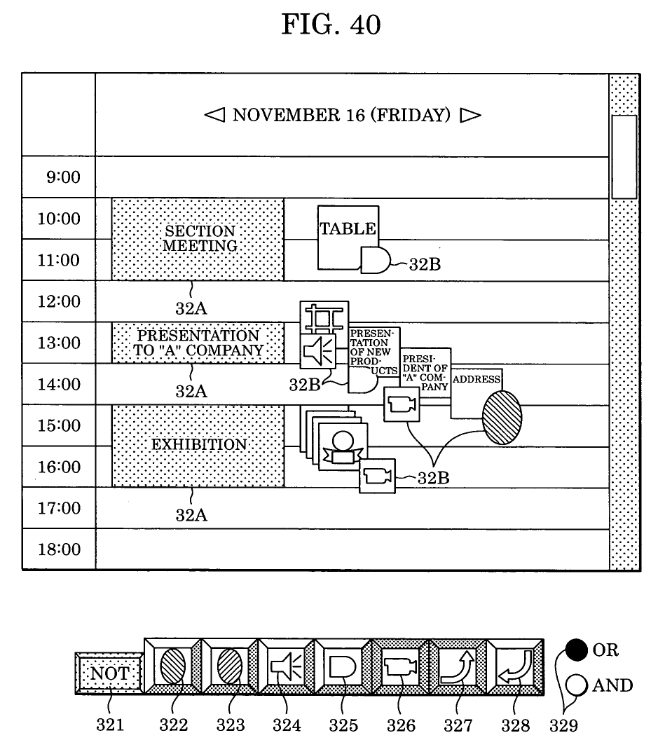

FIG. 32, FIG. 34, FIG. 36, FIG. 38, and FIG. 40 show examples of manners in which process types designated and correspondingly process information and schedules are displayed in the calendar view form according to the fourth embodiment. In each example of the calendar view form, operation means for designating the “NOT” flag, the “AND” flag, and process types is displayed, and a list of process information satisfying the designated conditions is displayed.

FIG. 31 shows an example of process type designation information, in which “OR” is designated for all process types displayed on the operation screen shown in FIG. 32.

Furthermore, in the example of the process type designation information shown in FIG. 31, the “NOT” flag is set to “false”, the “AND/OR” flag is set to “OR”, and all possible process types (kind) are selected in the process type list.

In FIG. 32, process type designation information 321 to 329 are displayed in the form of icons, and descriptions of scheduled events/jobs 32A and indicators of process information 32B are displayed at corresponding time positions in a time-day schedule view form.

The process type designation icons include a “NOT” icon 321, a “Create” icon 322, an “Update” icon 323, an “Alarm” icon 324, a “Present” icon 325, a “Camera” icon 326, a “Send” icon 327, a “Receive” icon 328, and an “AND/OR” icon (radio button) 329. When any of icons 321 to 328 is activated, the icon is highlighted. Inactive icons are displayed such that a lower edge part and a right edge part are shaded.

In the example shown in FIG. 32, the “NOT” icon 321 is inactivated, all process type designation icons 322 to 329 are activated, and the “AND/OR” icon is set to “OR”.

FIG. 33 shows an example of the process type designation information in a case in which any one of process types are selected on the operation screen shown in FIG. 34.

In the process type designation information shown in FIG. 33, the “NOT” flag is set to “false”, the “AND/OR” flag is set to “OR”, and no process types (kind) are selected in the process type list.

As a result, no process information is displayed in the time-day schedule view form shown in FIG. 34.

In FIG. 34, the process type designation icons are set such that the “NOT” icon 321 is inactivated, all process type designation icons 322 to 329 are inactivated, and the “AND/OR” icon is set to “OR”.

FIG. 35 shows an example of process type designation information in a case in which “Alarm” and “Present” are selected, and “OR” is designated for these selected process types on the operation screen shown in FIG. 36.

In the process type designation information shown in FIG. 35, the “NOT” flag is set to “false”, the “AND/OR” flag is set to “OR”, and “Alarm” and “Present” are selected in the process type (kind) list.

As a result, in FIG. 36, process indicators of “Alarm” and “Present” are displayed at specified time positions.

In FIG. 36, the process type designation icons are set such that the “NOT” icon 321 is inactivated, icons 322, 323, and 326 to 328 are inactivated, icons 324 and 325 are activated, and the “AND/OR” icon is set to “OR”.

FIG. 37 shows an example of process type designation information, in a case in which “Camera” and “Send” are selected, and “AND” is designated for these selected process types on the operation screen shown in FIG. 38.

In the process type designation information shown in FIG. 37, the “NOT” flag is set to “false”, the “AND/OR” flag is set to “AND”, and “Camera” and “Send” are selected in the process type (kind) list.

As a result, in FIG. 38, a process information indicator of process information that satisfies both the “Camera” and “Send” process types is displayed at a corresponding time position.

In FIG. 38, the process type designation icons are set such that the “NOT” icon 321 is inactivated, icons 322 to 325 and 328 are inactivated, icons 326 and 327 are activated, and the “AND/OR” icon is set to “AND”.

In FIGS. 37 and 38, if “NOT” is changed to “true” from “false”, the process type designation information and the operation screen become as shown in FIGS. 39 and 40, respectively. That is, in response to changing of “NOT” into “true”, process information indicators of process information that are not displayed in the state in which “AND” are designated for “Camera” and “Send” process types in FIG. 38 are displayed as shown in FIG. 40.

In the process type designation information shown in FIG. 39, the “NOT” flag is set to “true”, the “AND/OR” flag is set to “AND”, and “Camera” and “Send” are selected in the process type list.

As a result, in FIG. 40, process information indicators of process information, other than those that satisfy both the “Camera” and “Send” process types, are displayed at corresponding time positions.

In FIG. 40, the process type designation icons are set such that the “NOT” icon 321 is activated, icons 322 to 325 and 328 are inactivated, icons 326 and 327 are activated, and the “AND/OR” icon is set to “AND”.

In the fourth embodiment, as described above, process information corresponding to an operation performed by a user, an event that has occurred, and/or a schedule, can be extracted based on a condition specified by the user and displayed in a manner in which process types are explicitly indicated. This allows the user to easily retrieve data that was processed or is to be processed.

The present invention may be applied to various types of systems which may include either a single device, such as a copying machine or a facsimile machine as with the information processing apparatus shown in FIG. 1, or a plurality of devices, such as a host computer, an interface device, a reader, a printer, etc.

A storage medium having software program code stored thereon may be provided to a system or an apparatus for implementing the functions of the present invention, disclosed in the embodiments described above, and by reading and executing the program code on a computer (or a CPU or an MPU) disposed in the system or the apparatus.

In this case, it should be understood that the software program code read from the storage medium implements the functions of the invention and thus the software program code falls within the scope of present invention.

Storage media which can be employed in the present invention to store the program code include a floppy disk, hard disk, optical disk, magneto-optical disk, CD-ROM, CD-R, magnetic tape, nonvolatile memory card, and ROM.

The functions disclosed in the embodiments may be implemented not only by executing the program code on a computer, but part or all of the processes may be performed by an operating system or the like running on the computer in accordance with a command issued by the program code.

Furthermore, the program code may be loaded from a storage medium into a memory provided on an expansion board inserted into the computer or an expansion unit connected to the computer, and a part or all of the process may be executed by a CPU or the like provided on the expansion board or the expansion unit thereby realizing the functions according to the invention.

When the present invention is practiced using such a storage medium, a program code corresponding to a process according to one of embodiments described above with reference to a flow chart is stored on the storage medium.

While the present invention has been described with reference to exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2004-088320 filed Mar. 25, 2004, which is hereby incorporated by reference herein.

1. An information processing apparatus comprising:
a schedule database in which schedule data is stored;
a process information database in which process information is stored together with information indicating a time at which the information was processed; and
display means for displaying schedule data stored in the schedule database and process information stored in the process information database such that the schedule data and the process information are displayed at a position corresponding to a scheduled time in a calendar view form.

2. An information processing apparatus according to claim 1, wherein the display means displays process information by using an indicator corresponding to each process information.

3. An information processing apparatus according to claim 2, wherein the display means comprises:
first indicator generation means for generating an indicator indicating a content of the process information;
determinating means for determining whether the indicator indicating the content of the process information has been successfully generated by the first indicator generation means; and
second indicator generation means for generating an indicator indicating the type of the process information, when the determining means has determined that the generation of the indicator indicating the content of the process information has failed, wherein
when the determining means has determined that the indicator indicating the content of the process information has been successfully generated, the display means displays the process information in the calendar view form, using the indicator generated by the first indicator generation means, and
wherein when the determining means has determined that the generation of the indicator indicating the content of the process information has failed, the process information is displayed, in the calendar view form, using the indicator generated by the second indicator generation means.

4. An information processing apparatus according to claim 1, wherein the display means displays the process information in the calendar view form by using an indicator generated based on the process information and the type of a process performed on the process information.

5. An information processing apparatus according to claim 4, wherein the indicator of the process information is generated by combining an indicator generated based on the process information and an indicator generated based on the type of the process performed on the process information.

6. An information processing apparatus according to claim 4, wherein the process performed on the process information includes a plurality of types of processes.

7. An information processing apparatus according to claim 1, wherein the display means further comprises a period setting means for setting a period displayed in the calendar view form.

8. An information processing apparatus according to claim 1, wherein the display means further comprises selection means for selecting process information to be displayed in the calendar view form, based on the type of the process performed on the process information.

9. An information processing apparatus according to claim 8, wherein the selection means selects process information to be displayed by using a button interface indicating types of processes.

10. An information processing apparatus according to claim 1, wherein when a list display command is issued by a user, the display means displays a list of process information by using an indicator generated based on each process information and the type of the process performed on the process information.

11. An information processing method for controlling an information processing apparatus comprising a schedule database in which schedule data is stored, and a process information database in which process information is stored together with information indicating a time at which the information was processed, the method comprising:
displaying schedule data stored in the schedule database and process information stored in the process information database such that the schedule data and the process information are displayed at a position corresponding to a scheduled time in a calendar view form.

12. An information processing method according to claim 11, wherein the process information is displayed by using an indicator corresponding to each process information.

13. An information processing method according to claim 12, displaying the process information comprises:
a first indicator generation step in which an indicator indicating a content of the process information is generated;
a determining step in which determination is made as to whether the indicator indicating the content of the process information has been successfully generated in the first indicator generation means; and
a second indicator generation step in which an indicator indicating the type of the process information is generated when it has been determined in the determining step that the generation of the indicator indicating the content of the process information has failed, wherein
when the determining step has determined that the indicator indicating the content of the process information has been successfully generated, the process information is displayed, in the calendar view form, using the indicator generated in the first indicator generation step, and
wherein when the determining step has determined that the generation of the indicator indicating the content of the process information has failed, the process information is displayed, in the calendar view form, using the indicator generated by the second indicator generation step.

14. An information processing method according to claim 11, wherein the process information is displayed in the calendar view form by using an indicator generated based on the process information and the type of a process performed on the process information.

15. An information processing method according to claim 14, wherein the indicator of the process information is generated by combining an indicator generated based on the process information and an indicator generated based on the type of the process performed on the process information.

16. An information processing method according to claim 14, wherein the process performed on the process information includes a plurality of types of processes.

17. An information processing method according to claim 11, further comprising a period setting step in which a period displayed in the calendar view form is set.

18. An information processing method according to claim 11, further comprising selecting which process information to be displayed in the calendar view form is selected based on the type of the process performed on the process information.

19. An information processing method according to claim 18, wherein process information to be displayed is selected by using a button interface indicating types of processes.

20. An information processing method according to claim 11, wherein when a list display command is issued by a user, a list of process information is displayed by using an indicator generated based on each process information and the type of the process performed on the process information.

21. Computer-executable process steps for controlling a computer by using a schedule database in which schedule data is stored, and a process information database in which process information is stored together with time information indicating a time at which the information was processed, the computer-executable process steps causing the computer to execute the step of displaying schedule data stored in the schedule database and process information stored in the process information database such that the schedule data and the process information are displayed at a position corresponding to a scheduled time in a calendar view form.

22. Computer-executable process steps according to claim 21, wherein schedule data stored in the schedule database and an indicator generated based on the process information stored in the process information database and the type of the process performed on the process information are displayed at the time position corresponding to the scheduled time in the calendar view form.

23. Computer-readable storage medium on which computer-executable process steps according to claim 21 are stored.
